(19) United States
(12) Patent Application Publication
(10) Pub. No.: US 2009/0043643 A1
(43) Pub. Date: Feb. 12, 2009

(54) Managerial decision support system and method

(75) Inventors: Koichi Kitamura, Brookline, MA (US); Kentaro Taguchi, Fujisawa-shi (JP); Teruo Nakata, Fujisawa-shi (JP); Satoshi Katsube, Hiratsuka-shi (JP)

Correspondence Address: MATTINGLY, STANGER, MALUR & BRUNDIDGE, P.C., 1800 DIAGONAL ROAD, SUITE 370, ALEXANDRIA, VA, 22314, US

(73) Assignee: Hitachi, Ltd., Tokyo (JP)

(21) Appl. No.: 12/222,144

(22) Filed: Aug. 4, 2008

Related U.S. Application Data
(62) Division of application No. 10/382,918, filed on Mar. 7, 2003.

(30) Foreign Application Priority Data
Jun. 13, 2002 (JP) 2002-172200

(51) Int. Cl. G06F 17/30

(52) U.S. Cl. 705/10

(57) ABSTRACT

The system and method accepts the inputs of an aggregate (long-range) production plan draft, a profit and loss target, a sales target, and a stock target. Then, the accepted long-range production plan draft is deployed into master production schedule and then a feasibility of the long-range production schedule draft is simulated. Based on the simulated result, the system and method calculates an amended schedule, a predicted profit and loss, and predicted sales of the long-range production schedule draft. Further, a supply schedule is calculated on the middle-range production schedule draft deployed from the long-range plan draft. Based on the supply schedule, the middle-range production schedule draft, and a planned buying unit price, the system and method calculates a predicted stock, an estimated loss of inventory price decline, and a planned acquisition cost of inventory. Each calculated prediction data item is displayed on screen.

### RELATED APPLICATIONS

This application is a divisional of U.S. patent application Ser. No. 10/382,918, filed Mar. 7, 2003, now abandoned, the contents of which are incorporated herein by reference.

### BACKGROUND OF THE INVENTION

The present invention relates to a managerial decision support system and method to be executed in the case of selling and producing a middle or great deal of products.

As described in the “Introduction to Production Management 1” written by Takahiro FUJIMOTO and published in Nihon Keizai Shimbun, Inc. (Japan Economic Newspaper, Inc.), for drafting a schedule of selling or producing a middle or great deal of products, at first, an aggregate (long-range) production plan (referred to as a long-range schedule) is drafted for calculating a production level, a stock level, and a work level. Then, based on the long-range schedule, a master production schedule (referred to as a middle-range schedule) is drafted for fixing a production of each product and prepositions of a schedule on a number of man-hours and a schedule on a required amount of each material. The long-range schedule, as an example, includes the following attributes; the schedule period ranges from six months to one year and a half, the schedule unit is a month or a week, the frequency of a schedule revision is “per month”, and the product category is “on a product group basis”. On the other hand, the middle-range schedule includes the following attributes; the schedule period ranges from one to three months, the schedule unit is ten days to a day, the frequency of a schedule revision is “per month”, and the product category is “on a specification basis”. It is to be understood from the difference of each attribute between both of the schedules that the target business is influenced by the long-range schedule more greatly than by the middle-range schedule. It means that the middle-range schedule is drafted at an aim of the long-range schedule. Hence, the long-range schedule is drafted and approved by a top authority of the management (referred to as an executive or an executive person) for generally conducting the concerned business. The middle-range schedule is drafted and approved by sales and product authorities (referred to as sales and production manager) of the concerned business. For the long-range schedule or the middle-range schedule, in advance of the scheduled period, the schedule over the scheduled period is drafted and modified frequently at each modifying time.

In drafting the schedule, the executive drafts the long-range schedule and then the sales and product managers draft the middle-range schedule based on the long-range schedule. In reviewing the long-range schedule, a problem is focused on a contract of supplying materials (referred to as a supply constraint) and a constraint of an employment contract and a capacity of scheduled introducing facilities (referred to as a capacity constraint), which have been already arranged. Hence, after the long-range schedule is reviewed, the sales and product managers expand the long-range schedule into the middle-range schedule and then checks the feasibility of the long-range schedule in the supply constraint and the capacity constraint. If not feasible, the executive and the sales and product managers review the long-range schedule and the middle-range schedule again and again in cooperation with each other.

From a viewpoint of the executive, the conventional method of laying down the long-range schedule has the following disadvantages.

1: Mismatch of the long-range schedule to the middle-range schedule

2: No consideration is given to the information about profit-and-loss determination such as sales, costs, and profits in laying out the long-term schedule (schedule on the number of productions and sales).

3: If the information about the item 2 is supplied, no display means is provided for working the information into the easily determinable displaying form so that the information may be quickly determined.

Hereafter, each disadvantage will be described in detail.

About the disadvantage 1:

As mentioned above, the long-range schedule includes only the schedule on each product group. On the other hand, in the middle-range schedule, the feasible schedule is drafted on a production specification basis in the range of the supply constraint and the capacity constraint. If the long-range schedule is reviewed in spite of disability to grasp a parent relation between the product group of the long-range schedule and the product specification of the middle-range schedule before the review and a relation between the quantity of the long-range schedule and that of the middle-range schedule, the new, reviewed long-range schedule is not matched with the new, reviewed middle-range schedule. Further, unless the long-range schedule is expanded into the middle-range schedule, the supply and the capacity constraints are not allowed to be reviewed. Hence, the feasibility of the schedule cannot be grasped when drafting the long-range schedule. Until the long-range schedule is expanded into the middle-range schedule, the supply and the capacity constraints are reviewed, and the middle-range schedule is determined to be unfeasible, it is not grasped that the long-range schedule is made unfeasible. If the middle-range schedule is determined to be unfeasible, the review of the long-range schedule and the middle-range schedule are required to be repeated until the middle-range schedule is made feasible. Hence, it is difficult to keep the excellent match of both schedules.

About the disadvantage 2:

Conventionally, the profit-and-loss determination has been separated from the schedule draft on the sales and the production. This is because the aim of the schedule is to achieve the sales target in which the gross profit of each product (=price−standard cost) is at least plus and thus only the recovery of the fixed cost is required. If the gross profit is plus, a more sales profit than the gross one directly leads to the benefit. The conventional goal has been only to exceed the sales estimate. That is, if the product is so competitive that it may reach so large a number of sales and gross profit as recovering the fixed cost, it is just necessary to lower the manufacturing cost as much as possible and to produce and sale the target quantity of sales. Hence, it is not necessary to consider the profit and loss in the sales and production. However, in the managing circumstances wherein the product is not so competitive as having a lower profit ratio or obtaining so small sales as recovering the fixed cost, a variety of sales quantity has a great influence on the profit and loss. In particular, if two or more products are prepared and those products have their own profit ratios and accuracy on forecasting the demands of them, the sales quantity of each product has a great influence on the profit and loss. In such severs managing circumstances, the conventional method has had difficulty in determining the profit and loss of each product subtlety.

About the disadvantage 3:

The measures of sales, cost, profit, and stock are related with one another. For example, the increase of the sales ordinarily leads to the increase of the profit. The increase of the sales ordinarily leads to the increase of the stock. The increase of the cost leads to the increase of the stock. Hence, if these measures are displayed individually, it is necessary to take a time in reading the relation among them. That is, though it is necessary to increase the number of measures for the purpose of decision making, if those measures are displayed as they are, the decision making is made slower against the intention.

### SUMMARY OF THE INVENTION

In order to overcome the foregoing disadvantages, according to an aspect of the invention, by referring to the relation between the long-range schedule and the middle-range schedule before review, the reviewed long-range schedule is promptly expanded into the reviewed middle-range schedule. Then, based on the result that it is determined whether or not the middle-range schedule stays in the range of the supply and the capacity constraints, the feasibility of the reviewed long-distance schedule is displayed. Further, based on the relation between the long-range schedule and the middle-range schedule before review, the reviewed middle-range schedule is reversely expanded into the long-range schedule and then is displayed. Moreover, the influence given by the variety of actual demand against the sales schedule is predicted and the predicted result is supplied as the materials of determining the management to the system located on the side of the executive.

In order to overcome the foregoing disadvantages, according to another aspect of the invention, the predicted results of sales, cost, and profit on the long-range schedule level (product category, schedule period, and schedule unit) are calculated on the corresponding middle-range schedule. The predicted results are outputted on the display device on which the executive makes a managerial decision. Further, the profit-and-loss information (sales, profit, and cost) based on the reviewed result of the middle-range schedule based on the reviewed long-range schedule is outputted on the display device on which the managerial decision is made in such a graphical manner as combining the measures with each other so that the executive may easily make a decision. In improving the estimating accuracy of the cost, it is necessary to predict the change of acquisition cost of parts resulting from the change of the predicted stock caused by the revised sales schedule. Further, it is also necessary to predict the influence on the profit and loss if the actual demand against the sales schedule is changed.

Concretely, the long-range schedule is drafted on the shifted measures such as sales, a cost, a profit, and a stock from the past. Then, the shifts of each index and the relation among the measures are viewed at a time. For example, the shift of the ratio of the sales to the profit, which corresponds to the relation between the sales and the profit, is displayed at a time together with the shift of the sales.

In updating the long-range schedule, the current values of the measures such as sales, a cost, a profit, and a stock are displayed. A method is also provided of displaying the information about how far the current values of these measures are shifted from the schedule or the budget achievement level based on the future prediction values so that the concerned persons may view the information. In combination, the method is also provided of displaying the relation among the current values of the measures, about the current shift, and the budget achievement predictions so that the concerned persons may view the relation.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a system configuration and various pieces of information to be transferred among the devices;

FIG. 2 is a view showing an example of a process of exchanging information among the devices;

FIG. 3 is a view showing a shift of a display provided by a managerial decision support device;

FIG. 4 is a graph showing an example of a display of the actual results given by the managerial decision support device;

FIG. 5 is a view showing a screen on which display items of the actual results are to be selected;

FIG. 6 is a view showing a screen on which measures of the actual results are to be selected;

FIG. 7 is a view showing an example of a screen on which the target values of managerial measures are to be selected;

FIG. 8 is a view showing an example of a screen on which the actual estimates are displayed;

FIG. 9 is a view showing an example of a screen on which the display items of the actual estimates are to be selected;

FIG. 10 is a view showing an example of a screen on which the measures of the actual estimates are to be selected;

FIG. 11 is a view showing an example of a screen on which the target values of the managerial measures are to be reviewed;

FIG. 12 is a view showing an example of a screen on which a long-range schedule is to be edited;

FIG. 13 is a view showing a functional arrangement of the managerial decision support;

FIG. 14 is a view showing a structure of actual sales data;

FIG. 15 is a view showing a structure of actual profit-and-loss data;

FIG. 16 is a view showing a structure of actual production data;

FIG. 17 is a view showing a structure of actual stock data;

FIG. 18 is a view showing a data structure of a long-range schedule draft;

FIG. 19 is a view showing a data structure of a profit and loss goal;

FIG. 20 is a view showing a data structure of a sales goal;

FIG. 21 is a view showing a data structure of a stock goal;

FIG. 22 is a view showing a structure of predicted sales data;

FIG. 23 is a view showing a structure of predicted profit and loss data;

FIG. 24 is a view showing a structure of predicted stocks data;

FIG. 25 is a view showing a structure of predicted estimated loss data;

FIG. 26 is a view showing transfer of information mainly through the system for supporting a decision on a profit and loss;

FIG. 27 is a view showing an example of a process of exchanging information among the devices composing the system;

FIG. 28 is a block diagram showing a functional arrangement of a profit and loss simulating device;

FIG. 29 is a flowchart showing a function of expanding the long-range schedule in detail;

FIG. 30 is a flowchart showing a function of checking a feasibility in detail;

FIG. 31 is a flowchart showing a function of calculating a profit and loss in detail;

FIG. 32 is a block diagram showing a functional arrangement of a device for supporting a decision on a profit and loss;

FIG. 33 is a block diagram showing a display flow of a device for supporting a decision on a profit and loss;

FIG. 34 is a view showing an example of a screen of super bill of materials;

FIG. 35 is a view showing an example of a screen of changing an adding ratio;

FIG. 36 is a view showing an example of a screen of detailed information;

FIG. 37 is a view showing data on a large-range schedule draft;

FIG. 38 is a view showing data on aggregate plan deployment system;

FIG. 39 is a view showing data of deployment ratio;

FIG. 40 is a view showing data of a middle-range schedule draft;

FIG. 41 is a view showing data of an output result as to whether or not the schedule is feasible;

FIG. 42 is a view showing data of a planned discount price ratio;

FIG. 43 is a view showing data of a planned product selling price;

FIG. 44 is a view showing data of profit and loss, sales, and a cost;

FIG. 45 is a block diagram showing transfer of information mainly through a system for supporting a stock and supply schedule;

FIG. 46 is a view showing an example of a process of exchanging information among the devices composing the system;

FIG. 47 is a block diagram showing a functional arrangement of a stock simulating device;

FIG. 48 is a flowchart showing a function of calculating a stock in detail;

FIG. 49 is a flowchart showing a function of calculating a stock in detail;

FIG. 50 is a flowchart showing a functional arrangement of the device for supporting a supply schedule draft device;

FIG. 51 is a diagram showing a functional arrangement of a stock and supply schedule support device;

FIG. 52 is a view showing an example of a display in the function of changing the supply schedule;

FIG. 53 is a view showing an example of a display in the function of indicating the measures;

FIG. 54 is a view showing an exemplary display portion of a stock goal;

FIG. 55 is a view showing an exemplary display portion of a predicted stock;

FIG. 56 is a view showing an exemplary display portion of a predicted stock;

FIG. 57 is a view showing an example of data on a supply schedule draft;

FIG. 58 is a view showing an example of data on a predicted stock (a quantity and a sum);

FIG. 59 is a view showing an example of data on a middle-range schedule on a day basis; and

FIG. 60 is a view showing an example of data on an exchange rate.

### DESCRIPTION OF THE EMBODIMENTS

Hereafter, the description will be oriented to the managerial decision support system according to an embodiment of the present invention with reference to the appended drawings.

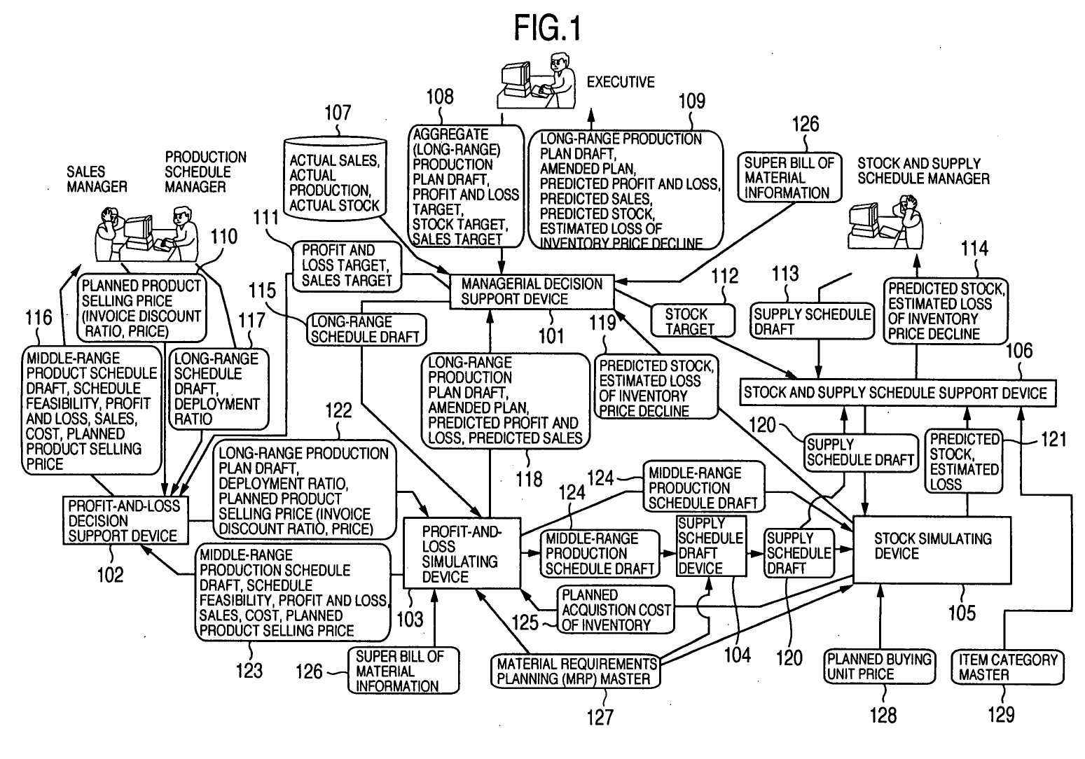

FIG. 1 is an explanatory view showing an arrangement of devices and a flow of information among the devices in the managerial decision support system according to an embodiment of the present invention. In FIG. 1, a numeral 101 denotes a managerial decision support device for supporting a new creation of a long-range schedule draft made by an executive and the change according to the progress of the schedule. A numeral 102 denotes a profit-and-loss decision support device that is arranged to allow the sales and product managers to create deployment ratio and a planned product price on the long-range schedule draft 108 inputted by the executive and displaying whether or not the long-range schedule 108 (or the modified long-range schedule draft 117) is feasible. A numeral 103 denotes a profit-and-loss simulating device that is arranged to predictively operating the feasibility of the long-range schedule 108 (A numeral 115 denotes data being transferred). A numeral 104 denotes a supply schedule draft device for drafting a parts supply schedule 120 based on the middle-range schedule draft 124 outputted by the profit-and-loss simulating device 103. A numeral 106 denotes a stock and supply schedule support device that is arranged to allow a stock and support manager to modify the supply schedule draft based on the stock goal 108 (A numeral 112 denotes data being transferred) inputted by the executive and the predicted stock 121 outputted by the stock simulating device 105. A numeral 105 denotes a stock simulating device that is arranged to predictively operate the predicted stock 121 based on the middle-range schedule draft 124 and the supply schedule draft 120 (or the modified supply schedule draft 113).

In this embodiment, the managerial decision support device 101 is inputted with the long-range schedule draft, a profit and loss goal, a sales goal, and a stock goal, all denoted by 108, inputted by the executive that is the top authority of the business. Then, the profit and loss goal and the sales goal 111 are transferred into the profit-and-loss decision support device 102, the stock goal 112 is transferred into the stock and supply schedule support device 106, and the long-range schedule draft 115 is shifted into the profit-and-loss simulating device 103 so that the profit-and-loss simulating device 103 and the stock simulating device 105 may be operated. As the operated result, the managerial decision support device 101 obtains the long-range schedule draft, an amended schedule, the predicted profit and loss, and the predicted sales, all denoted by 118, from the profit-and-loss simulating device 103 and a stock prediction and an estimated loss of a inventory price decline, all denoted by 119, from the stock simulating device 105. The managerial decision support device 101 provides the executive with the obtained informations in combination with the data on actual sales, actual production, and actual stock so that the executive may use all data for his or her decision making. In this arrangement, the transfer of data among the devices is executed by a communicating means such as the LAN (Local Area Network) or the internet.

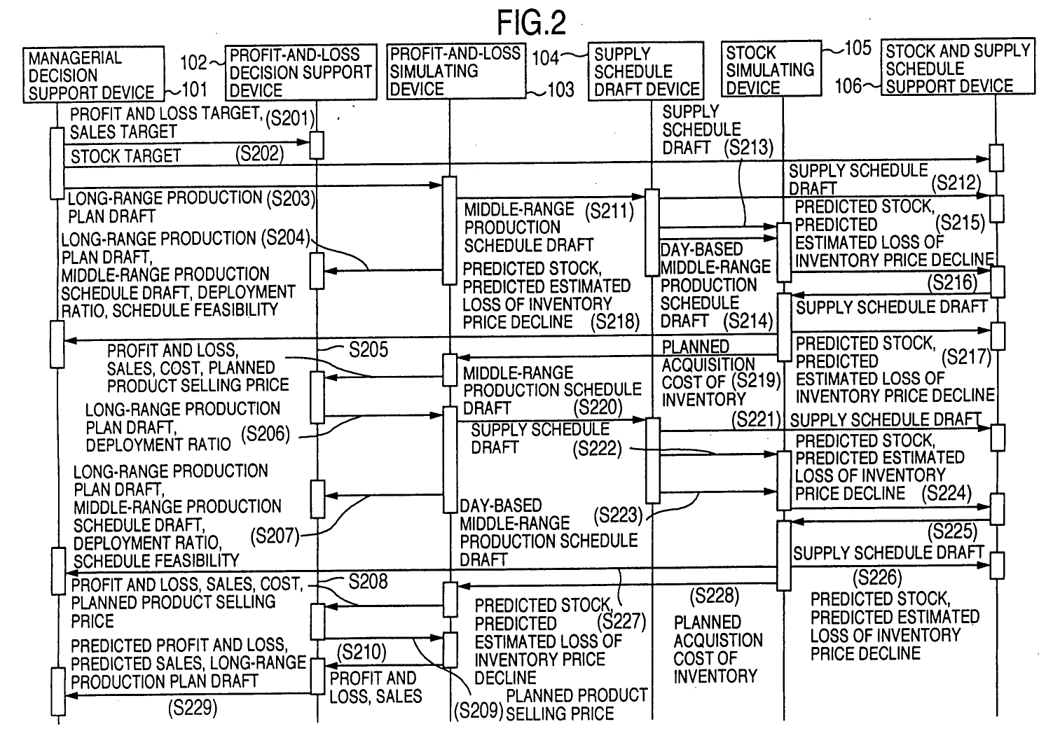

FIG. 2 is a sequence view showing the timings on which the informations are exchanged among the devices.

At first, the managerial decision support device 101 transmits the data on the profit and loss goal and the sales goal 111 to the profit-and-loss decision support device 102 (S201). The device 101 also transmits the data on the stock goal 112 to the stock and supply schedule support device 106 (S202). Further, the data on the long-range schedule draft 115 is transmitted from the managerial decision support device 101 to the profit-and-loss simulating device 103 (S203). At this time, an indication of start is transmitted from the managerial decision support device 101 to the profit-and-loss decision support device 102 and the stock and supply support device 106. In response to the indication of start, the profit-and-loss decision support device 102 accepts the inputs (such as the long-range schedule draft, the deployment ratio, all denoted by 117, and the planned product price 110) from the sales manager and the production manager and then transfer the long-range schedule draft, the ratio of deployment, and the planned product price, all denoted by 122, to the profit-and-loss simulating device 103. Then, the device 101 issues an indication of starting the profit-and-loss simulating device 103 and then transmit the indication to the device 103. In response to the indication of start, the profit-and-loss simulating device 103 causes the supply schedule draft device 104 and the stock simulating device 105 to start. Conversely, in response to the indication of start from the managerial decision support device 101, the stock and supply schedule support device 106 may cause the stock simulating device 105, the supply schedule draft device, and the profit-and-loss simulating device 103 to start. This converse process allows the management, profit-and-loss and stock system to be started up.

In succession, based on the long-range schedule draft transferred from the managerial decision support device 101, the deployment ratio (meaning the ratio of the sales to the production in the middle-range schedule draft) transferred from the profit-and-loss decision support device 102, and the planned product price of each product specification, the profit-and-loss simulating device 103 calculates the middle-range schedule draft and a feasibility of the schedule and then transfers the results to the profit-and-loss decision support device 102 (S204). The profit-and-loss simulating device 103 performs a predicting operation, in which the long-range schedule deploying operation is executed for calculating the middle-range schedule draft based on the long-range schedule draft, the super bill of materials 126 (see FIG. 1), and the deployment ratio. Afterwards, the feasibility of the schedule is executed by using the required amount calculating master 127. The concrete embodiment of the profit-and-loss decision support will be discussed with respect to the second embodiment.

Then, the profit-and-loss simulating device 103 calculates the predicted profit and loss, the predicted sales, the predicted cost, and the planned product price and then transmits them to the profit-and-loss decision support device 102. The calculated information is combined with the super bill of materials 126 and then the result is outputted onto the display screen of the profit-and-loss decision support device 102 in a tree structure format. As viewing the displayed information, the sales and production managers enable to change or modify the numerical values of the long-range schedule draft, the deployment ratio, and the planned product price through the use of the profit-and-loss decision support device 102. In this embodiment, the description concerns with the change or modification in a step S206 about the long-range schedule draft and the deployment ratio and the change or modification in a step S209 about the planned product price. These three data items may be modified or changed at a time (as the step S206). In the case, the predicted profit and loss and the predicted sales (S210) are operated at the same time of the operation in a step S207.

Then, in response to the input given by the sales and production managers, the profit-and-loss decision support device 102 transmits the long-range schedule draft and the deployment ratio (modified value) to the profit-and-loss simulating device 103 (S207). Then, based on the information like the modified long-range schedule, the profit-and-loss simulating device 103 executes the operation with respect to the deployment of the long-range schedule and the feasibility of the schedule and then transmits the operated result to the profit-and-loss decision support device 102 (S207).

Like the step S205, the predicted profit and loss, the predicted sales, the predicted cost, and the planned product price are calculated by the operation of the profit-and-loss simulating device 103. The calculated result is transmitted to the profit-and-loss decision support device 102. In response to the result, the sales and production managers enable to change or modify the planned product price. The modified data is transmitted to the profit-and-loss simulating device 103 (S209). Based on the modified, planned product price, the profit-and-loss simulating device 103 calculates the predicted profit and loss and the predicted sales and then transmits them to the profit-and-loss decision support device 102 (S210).

The supply schedule draft device 104 accepts the middle-range schedule data calculated by the profit-and-loss simulation (S220), drafts the supply schedule draft 120 again based on the middle-range schedule, and transmit the supply schedule draft 120 to each device (S221, S222). The supply schedule draft device 104 calculates the middle-range schedule draft on a day basis (S224). The stock simulating device 105 executes the operation of the stock prediction again (S224). If modified by the stock and supply manager, the supply schedule draft 113 is transmitted to the stock simulating device 105, in which the stock simulating calculation is executed. In this embodiment, the long-range schedule draft and the deployment ratio are changed and modified (S206). Hence, the re-calculating process in the steps S220 to S228 is executed. If only the planned product price is modified or changed, the re-calculating process is not executed. In place, the process in the step S210 is executed.

The re-calculated stock prediction data is transmitted to the stock and supply schedule support device 106 and the managerial decision support device 101 (S226 and S227). Then, the predicted profit and loss, the predicted sales, and the feasible long-range schedule draft are transmitted to the managerial decision support device 101, in which they are displayed on the screen in combination with the information transmitted in the step SS7.

The foregoing processing flow allows the managerial decision support device 101 to supply the executive with the long-range schedule draft, the feasibility, the predicted profit and loss, the predicted sales, and the predicted stock, all denotes by 109. The repetition of these processes makes it possible to supply the managerial decision support information in real time, thereby allowing the executive to determine the management quickly and properly.

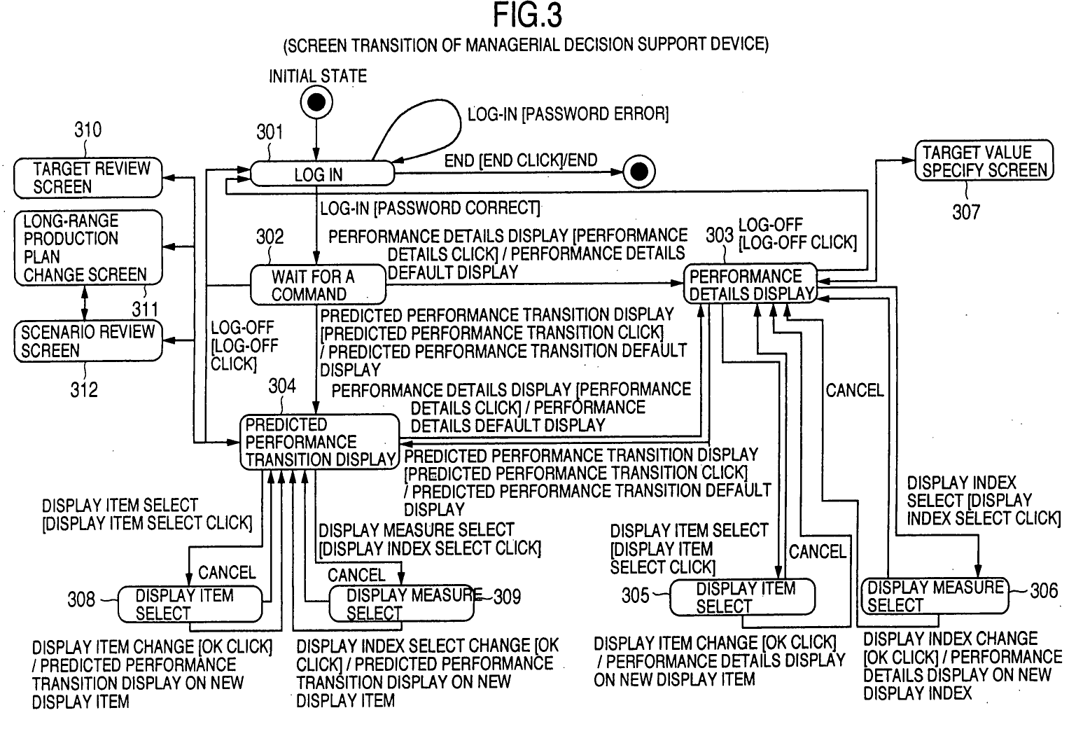

In turn, the description will be oriented to the screen display of the information supplied by the managerial decision support device 101 with reference to FIGS. 3 to 15.

FIG. 3 shows the screen transition of the managerial decision support device 101.

In the initial state, the user logs in the device 101 (301). Then, the device 101 enters into the waiting state for a command (302). In the waiting state, two commands may be executed. One command is for displaying the details of a performance, while the other command is for displaying the predicted transition of a performance (304). Each of the displays have some option functions. The display of the performance details includes as its option functions a display item display (305), a display measure selection (306), and a target value specify screen (307). The display of the predicted transition includes as its option functions a display item selection (308), a display measure selection (309), a target value review screen (310), a long-range schedule change screen (311), and a scenario review screen (312). Those functions are connected in the relation as shown in FIG. 3. The details will be described in explaining each function.

At first, the user enters a user ID and a password on the log-in screen (301) of the managerial decision support device 101 and clicks a log-in button. By this operation, the user is authenticated. Only if authenticated, the process is shifted to the next screen for waiting for a command (302).

The command awaited on the screen 302 is any one of the commands of displaying the transition of a predicted performance, displaying the details of the performance, and logging off the system. If the command of displaying the details of the performance is clicked, the display is shifted into the next display of the details of the performance (303). If the command of displaying the transition of the predicted performance is clicked, the display is shifted to the transition display of the predicated performance (304).

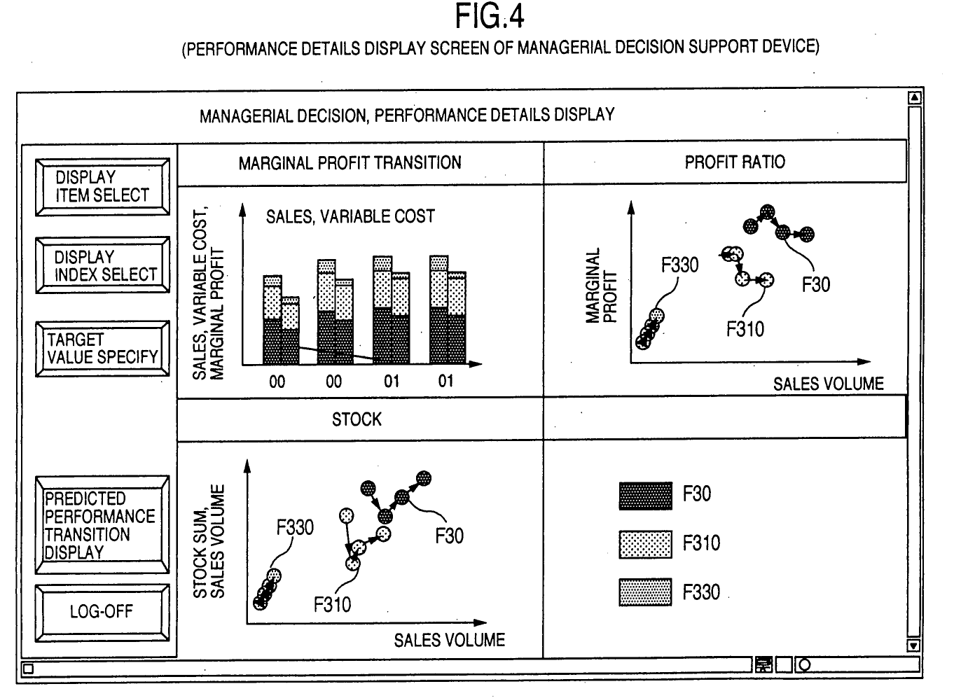

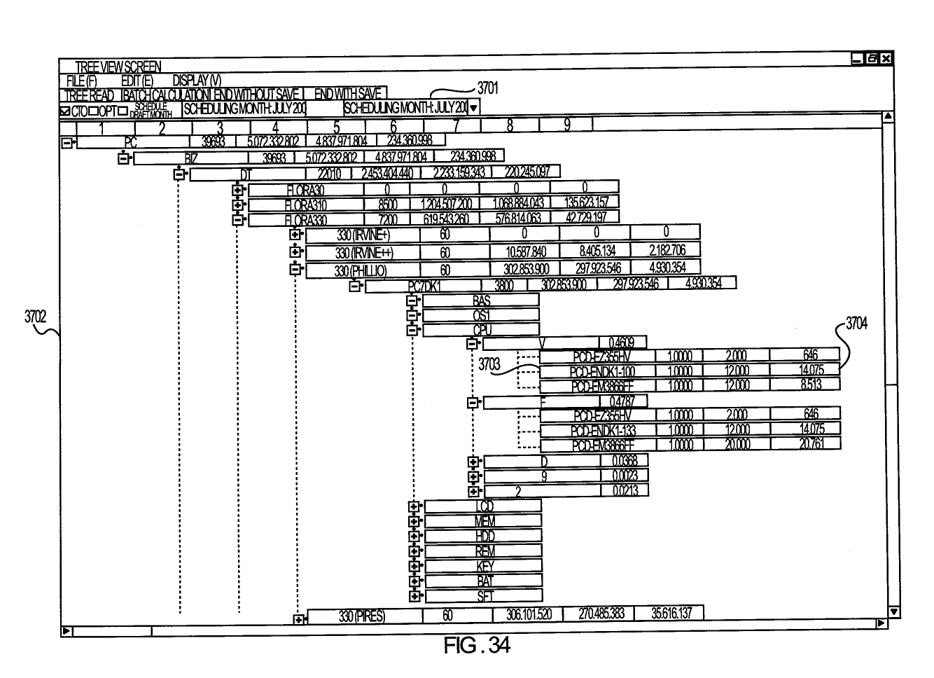

FIG. 4 shows an example of the screen on which the details of the performance are displayed. The screen shown in FIG. 4 is divided into four parts, three of which display the transition of a marginal profit (profit), the transition of a profit ratio, and the transition of a stock from the past, respectively and the other part of which displays the data on the product types (F30, F310, and F330). These displays are executed on the information accumulated in the databases 107 of the actual sales, the actual production, and the actual stock as shown in FIG. 1. The product group, which corresponds to the product category of the long-range schedule, is not limited to the foregoing product types (F330 or the like). It may be the group of the product format (CT: Client, PS: PC server, US: UNIX(R) server) belonging to the upper group than the product type group. They are related as the tree-structure as shown in FIG. 34, so that the executive may select any group level at his or her own will.

The transition graph of the marginal profit includes a bar graph of the past performance and a bar graph of the transition. In the former bar graph, an axis of abscissa indicates a period and an axis of ordinate indicates the sales and the variable cost. In the latter bar graph, an axis of abscissa indicates a period and an axis of ordinate indicates the marginal profit. The sales and the variable costs in the past periods are shaded and the marginal profits in the past are displayed in real lines. In this period (the second half (October to March) of 2001), the sales of the budget at the period outset and the variable cost of the budge at the period outset are shaded semi-transparently. The profit of the budge at the period outset is displayed by dotted lines.

In the profit ratio graph, an axis of abscissa indicates the sales of each period and an axis of ordinate indicates the marginal profit of each period. For each product type, the sales and the marginal profits in the past periods are displayed by real lines. In this period (the second half (October to March) of 2001), the sales of the budget at the period outset and the marginal profit of the budget at the period outset are displayed by semi-transparent lines. The sequence of the chronological information is indicated by an “arrow”. By displaying the relation between the marginal profit and the sales with the transition graph, it is possible to grasp the trends of two managerial decision measures at a time. Further, on the display format of this embodiment, the relation (profit ratio) between two measures, that is, the transition of the sales (upper or lower) and the transition of the marginal profit (upper or lower) can be instantaneously grasped so that the executive may determine the target values or the target value ranges of the “profit and loss target” and the “sales target” when he or she specifies the “profit and loss target” and the “sales target”. Further, in FIG. 4, for the product type F330, the profit ratio, which means a ratio of the profit to the sales, is high and its rising ratio is high as well. Hence, in a case that the executive intends to increase the profit, the executive can easily lay down the managerial policy of positioning the product type F330 whose sales volume is currently low as the weighted product type. As described above, the managerial decision support device 101 of this embodiment is arranged to quickly and properly support the draft of the managerial goal according to the policies of increasing the profit, the sales, and both the executive intends.

In the stock graph, an axis of abscissa indicates the sales of each period and an axis of ordinates indicates the stock sum of each period. For each product type, the stock sum in the past period is displayed by real lines. The stock sum of the budget at the outset of this period (the second half of 2001) is displayed by semi-transparent lines. The sequence of the chronological information is indicated by an “arrow”. By displaying the relation between the sales and the stock sum with the transition graph, like the profit ratio, it is possible to grasp two managerial decision measures at a time. If the stock sum is greater than the sales volume, the executive may easily lay down the managerial policy of positioning the concerned product type as the weighted product. Hence, it is possible to quickly and properly realize the executive's decision support of studying the stock target as considering the sales target.

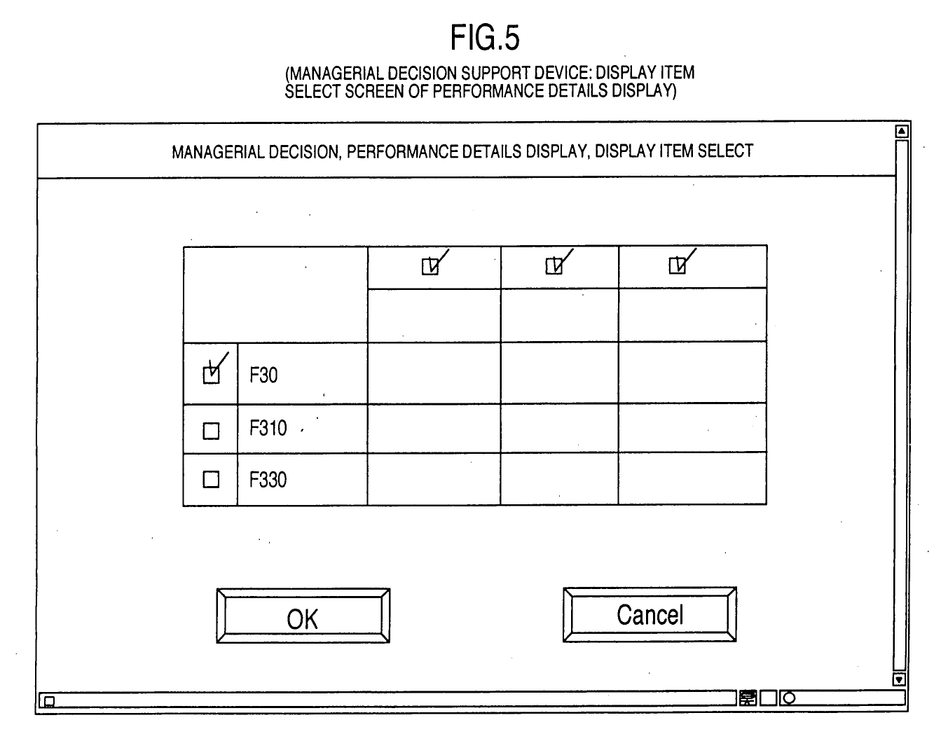

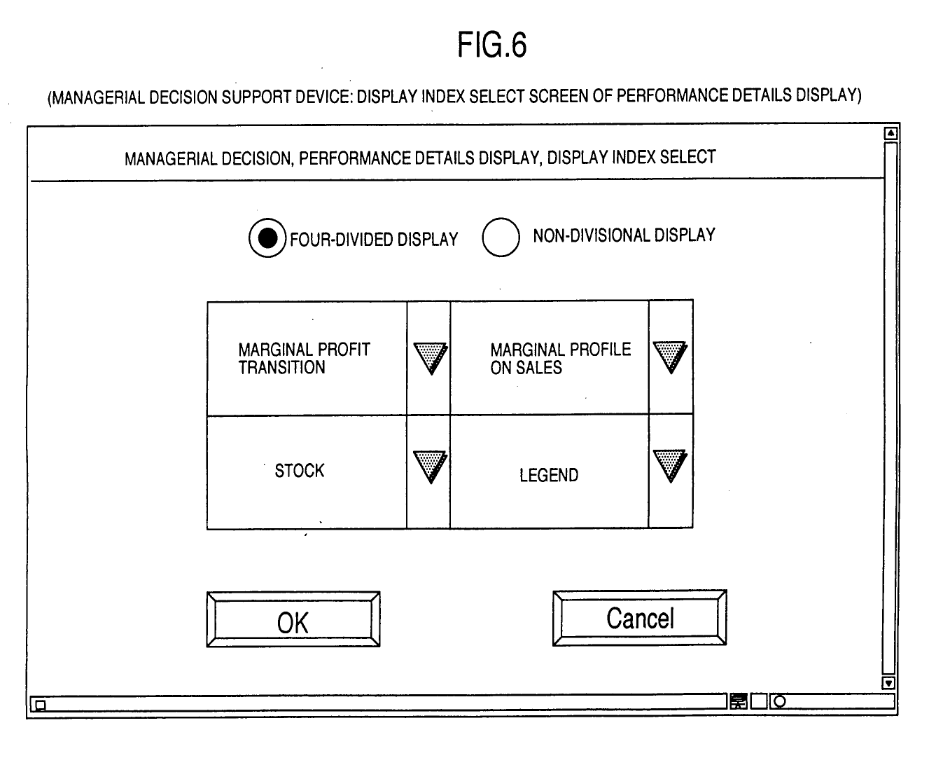

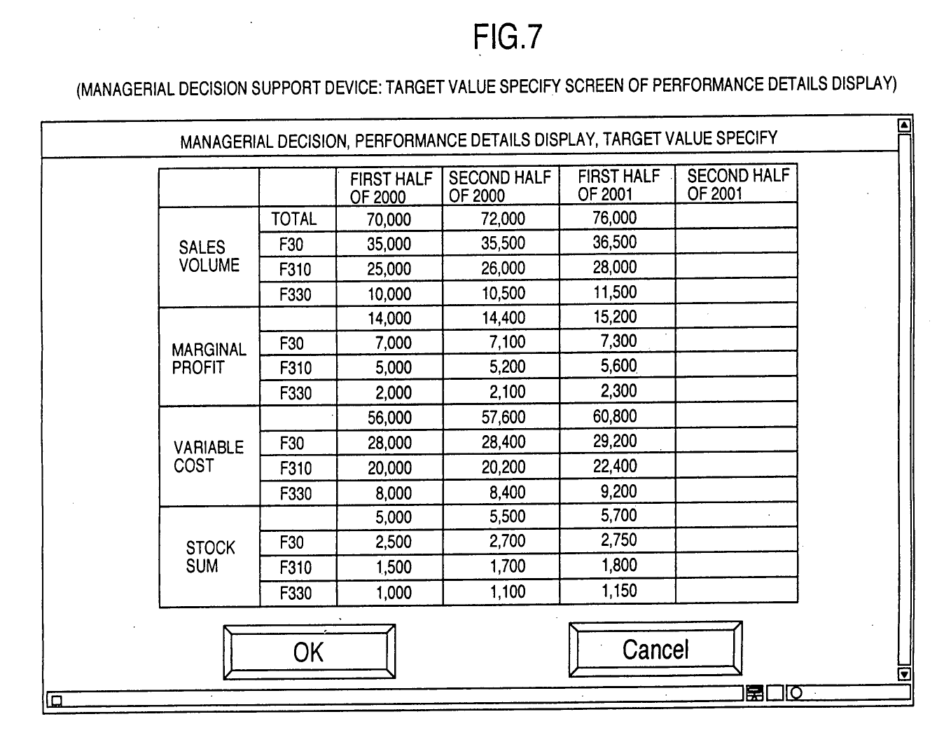

On the screen of the performance details display 303, three optional functions are provided as shown in the upper left portion of FIG. 4. They are a display item select 305, a display measure select 306, and a target value specify 307. When each button is clicked, the screen is shifted to the corresponding screen with the clicked button. The display item select 305 is shown in FIG. 5, the display measure select 306 is shown in FIG. 6, and the target value specify 307 is shown in FIG. 7. They will be described with reference to the corresponding figures.

On the screen of the performance details display 303, the other two buttons are provided. They are a predicted performance transition display button and a log-off button. When the former button is clicked, the screen is shifted to the predicted performance transition display 304. When the log-off button is clicked, the screen is shifted to the log-in screen 301.

FIG. 5 shows the display item select screen of the performance details display 303, in which an axis of abscissa denotes a period and an axis of ordinate denotes a product type. The check boxes are prepared for selection. At first, when this screen is displayed, the graph display status appears at that time. For example, if the data in the past three periods are displayed, the check boxes of three periods are selected on the screen. The color of the crossed field of the selected column and the selected row is changed from the other fields. If the OK is clicked, the graph of the combination of the checked items takes place.

FIG. 6 shows the display measure select screen of the performance details display 303. Any one of four-divided display and non-divisional display may be selected by a radio button. On the pull-down menu for the position of the graph, the content of display of each part may be selected. The three selective items are prepared, that is, the marginal profit transition, the profit ratio, and the stock. If the four-divided display is clicked, four pull-down menus are displayed. If the non-divisional display is clicked, one pull-down menu is displayed. At this time, the selective item in the upper left portion is succeeded. If OK is clicked, the graph of the combination of the selected items takes place. The graph is displayed on the performance details display 303. If the cancel button is clicked, the screen returns to the performance details display screen 303 without any change.

FIG. 7 is a target value specify screen of the performance details display 303, in which an axis of abscissa denotes a target item and its details and an axis of ordinate denotes a period. In this case, the target items are the sales volume, the marginal profit, the variable cost, and the stock sum. About each target value, as the details, the target items are prepared for each product type. The second half of 2001 is the target period at which the schedule is to be proceeded. The other periods are the past and the current ones. A concerned target value is entered into the field of the target period of the details. If the OK button is clicked, the value written in the field of the target period is read and then set as the target value. Then, the screen returns to the performance details display screen. If the cancel button is clicked, all entries are ignored, and then the screen returns to the performance details display screen. The present embodiment has been described with the system arranged so that the executive may directly enter the numerical values on the target value specify screen. In the graph of the performance details display screen 303 shown in FIG. 4, by clicking or fine tuning a position on the graph, the target numerical values may be entered. For example, in the graph of the profit ratio shown in FIG. 4, by clicking the target position after specifying a certain product type, it is possible to specify the sales target and the profit and loss (marginal profit) target at a time. In this case, by displaying the numerical values of the sales and the profit and loss (marginal profit) corresponding with the position of the pointer on the graph, the executive may more easily specify the target values.

On the target value specify screen (display screen included in the managerial decision support device 101) shown in FIG. 7, when the executive presses the OK button after specifying various target values, the target values about the profit and loss, the sales, and the stock are transmitted to the profit-and-loss decision support device 102, the profit-and-loss simulating device 103, and the stock and supply schedule support device 106. The process described with reference to FIG. 2 is executed to calculate various kinds of information such as a feasible long-range schedule draft, an amended schedule, a predicted profit and loss, a predicted sales, a predicted stock, and an estimated loss of inventory price decline (118, 119). These kinds of information are transmitted to the managerial decision support device 101. Then, the informations are edited and worked as the graphical data by the method to be discussed below and then are displayed on the screen (predicted performance transition display 304).

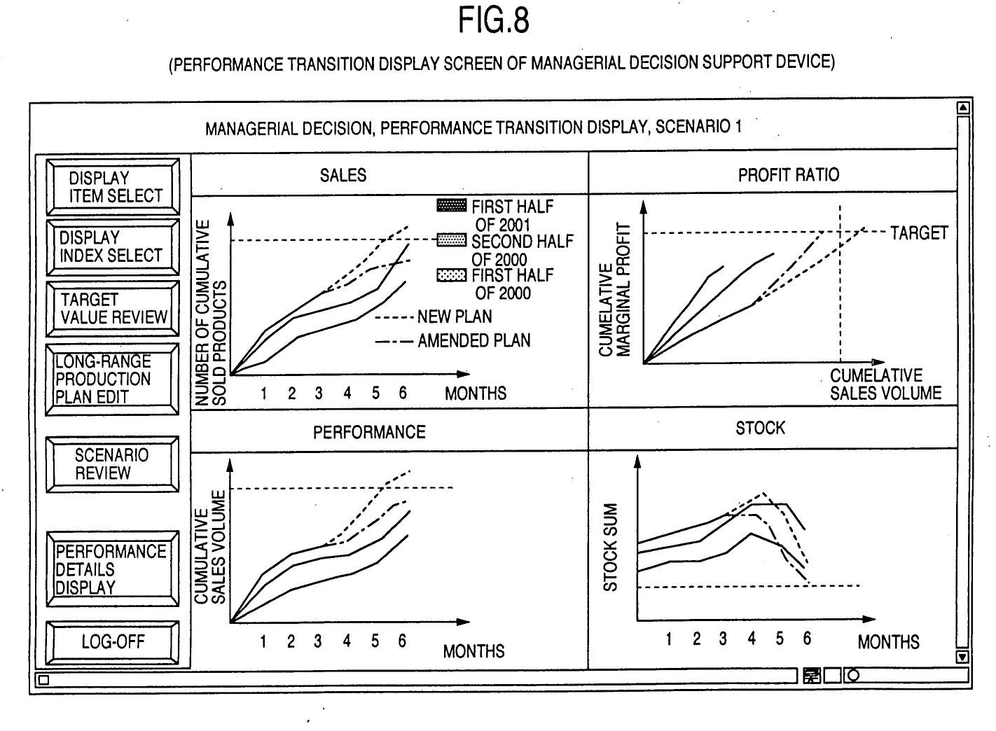

FIG. 8 shows the predicted performance transition display (actual transition display screen) 304. On the actual transition display 304, a plurality of managerial measures such as sales, a performance, a profit ratio, and a stock are allowed to be viewed at a time. The real-line graph indicates the actual transition earlier than the current time of the present period (the first half (March to September) of 2001) and in the previous periods. Based on the performance data including the actual sales, the actual production, and the actual stock stored in the database 107, the graphical data is generated. Further, the dotted-line graph indicates the transition of the predicted performance later than the current time of the present period (first half of 2001 (March to September). Based on the prediction data including the predicted profit and loss, the predicted sales, and the predicted stock, the graphical data is generated.

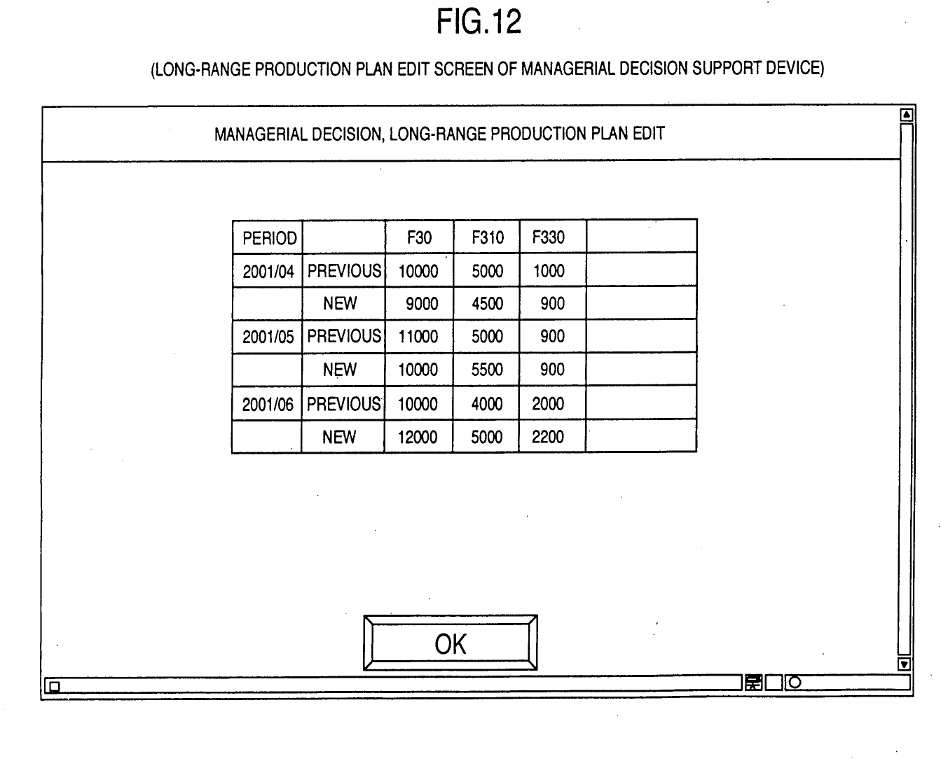

Of these measures, the stocked measures such as the sales, the number of products, and the profit are accumulatively displayed. By estimating the accumulated data, it is possible to easily grasp the progress against the target of the end of the period. Further, in the graph of the profit ratio shown in FIG. 8, the X axis indicates not a time but a sales measure. Though not shown, in the graph of the market measure, the X axis indicates the index like the number of products. Hence, it is possible to grasp the transition of each unit price according to the change ratio of the number of products to the sales and the transition of the profit ratio according to the change ratio of the profit to the sales on a small number of screens and at a time. Further, by selecting the overlap, on the screen, the data is overlapped with the data of the same period in the past read from the performance database 107. This makes it possible to easily estimate the current progress. Further, the future prediction values indicated by the dotted lines are calculated on the long-range schedule draft, the amended schedule (middle-range schedule), and the predicted demands through the effect of the profit-and-loss simulating device 103 and the stock simulating device 105 shown in FIG. 2 being operated in concert. FIG. 8 shows the future prediction graph calculated as described above. Herein, the new schedule of FIG. 8 is an accumulative graph display (on a month basis) of the managerial measure provided in the case of creating the middle-range schedule with the function of deploying the long-range schedule, as being constrained by the original long-range schedule value created on the long-range schedule editing screen shown in FIG. 12 by the executive. The amended schedule is an accumulative graph display (on a month basis) of the managerial measures based on the middle-range schedule created (modified and changed) by the sales and production manager through the effect of the profit-and-loss decision support device with reference to the middle-range schedule value expanded from the long-range schedule through the profit-and-loss simulating device 103.

The executive may review the managerial measures with reference to the information about the predicted performance transition display 304 appearing on the managerial decision support device 101. The support method will be described below.

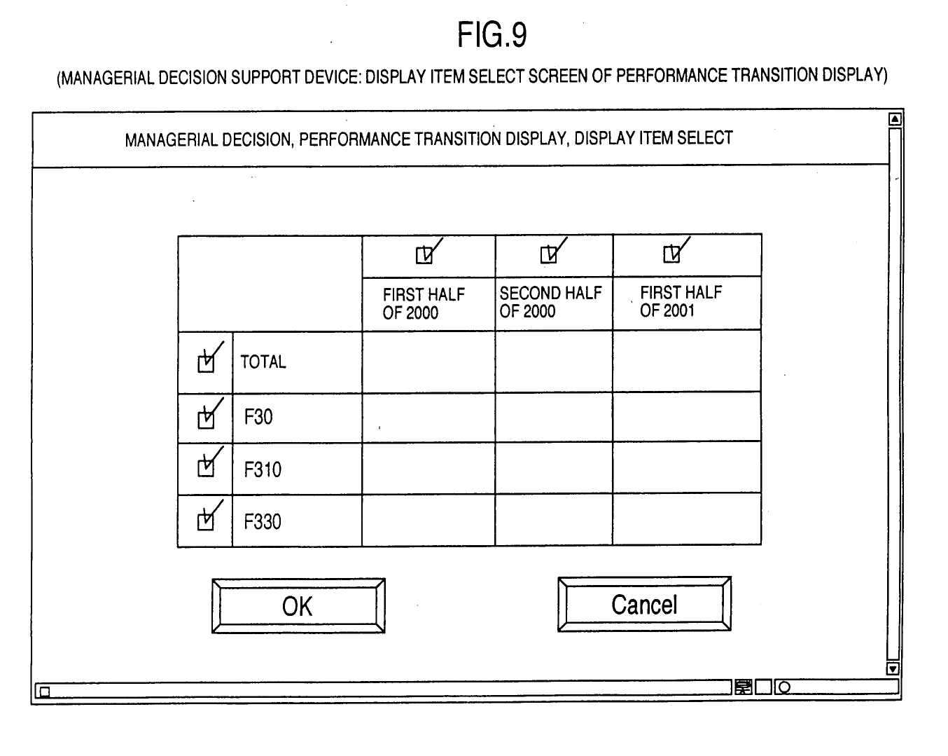

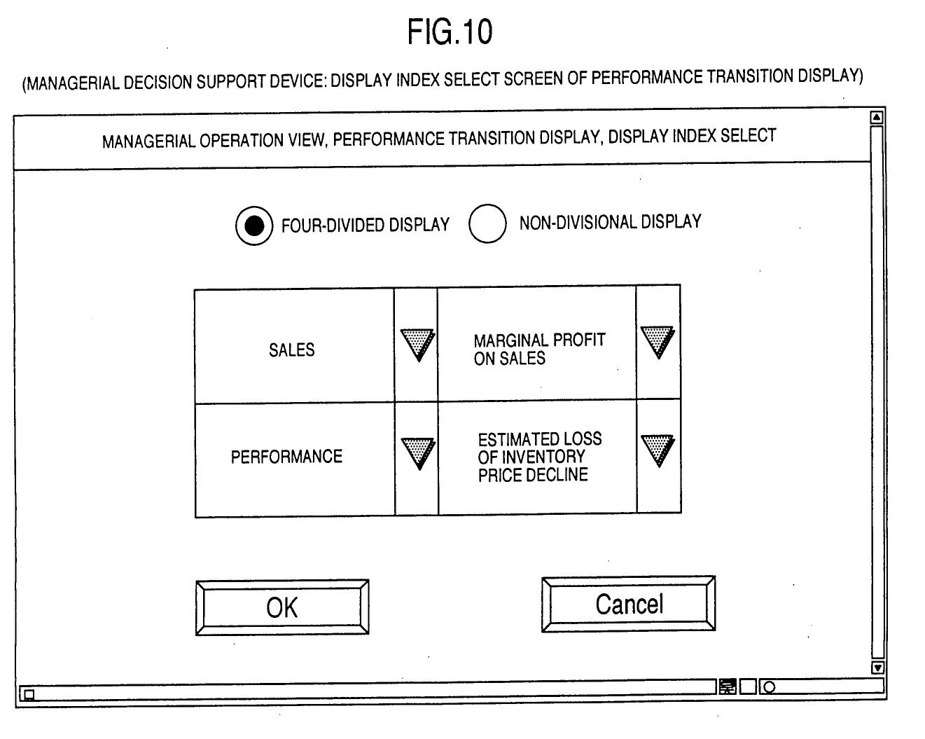

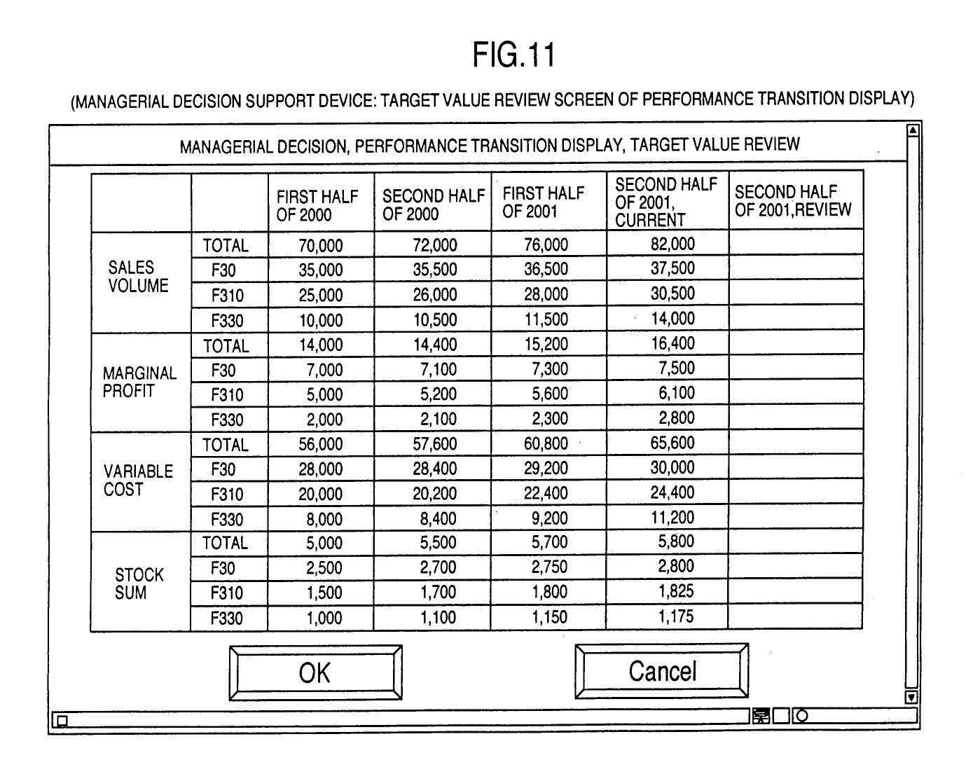

The predicted performance transition display 304 includes four optional functions. They are a display item select 308, a display measure select 309, a target value review 310, and a long-range schedule edit 311. When each of the buttons, as shown in the left hand of the screen of FIG. 8, is clicked, the screen is shifted to the corresponding screen with the clicked button. The display item select 308 is shown in FIG. 9, the display index select 309 is shown in FIG. 10, the target value review 310 is shown in FIG. 11, and the long-range schedule edit 311 is shown in FIG. 12. Those optional functions will be described later with reference to those figures.

FIG. 9 shows the display item select screen 308 of the performance transition, in which an axis of abscissa denotes a period and an axis of ordinate denotes a product type. Each period and each product type may be selected on the check box. At first, when this dialogue window is shown, the state at the time is displayed graphically. For example, if the data of the past three periods are displayed, the check boxes of the three periods are checked on the screen. The colors of the crossed fields of the checked columns and the checked rows are changed from the other fields. When the OK is clicked, the combination of the checked fields at this time takes place as a graph.

FIG. 10 shows the display index select screen 309 of the performance transition display. In FIG. 10, the four-divided display or the non-divisional display is selected by pressing the radio button. On the pull-down menu located in the graph position, the display content of each part may be selected. The selecting options are the sales, the performance, the profit ratio, and the stock. If the four-divided display is clicked, four pull-down menus are displayed. If the non-divisional display is clicked, only one pull-down menu is displayed. At a time, the selecting options in the upper left portion are succeeded. If the OK is clicked, the combination of the checked items at the time takes place as a graph, and then the screen returns to the performance transition display screen 304. When the cancel button is clicked, the screen returns to the performance transition display screen 304 without any change.

FIG. 11 shows the target value review screen 310 of the performance transition display, in which an axis of abscissa denotes the target items and their details and an axis of ordinate denotes the periods. In this case, the target items are the sales volume, the marginal profit, the variable cost, and the stock sum. As the details, each target value is divided by the number of the product types. In this case, the second half of 2001 corresponds to the current period and the other periods correspond to the past ones. The concerned target values are entered into the review fields of the second half of 2001 that corresponds to the current period of each detail. When the OK button is clicked, the values written in the review fields of the second half of 2001 are read and then are specified as the target values. Then, the screen returns to the performance display screen. The reviewed target values (that mean the target values of the long-range schedule draft, the profit and loss, the stock, the sales, and the like) are deployed by the simulation method described with reference to FIG. 2. Then, the new long-range schedule, the amended schedule, and various predicted values are modified and calculated out by the manager in the concerned charge and then are transmitted into the managerial decision support device 101.

FIG. 12 shows the long-range schedule edit screen 311 of the performance transition display. On this screen, an axis of abscissa denotes a product type and an axis of ordinate denotes a time bucket unit as the period. On this matrix is displayed the current long-range schedule (previous), on which the new long-range schedule is written in the “new” columns.

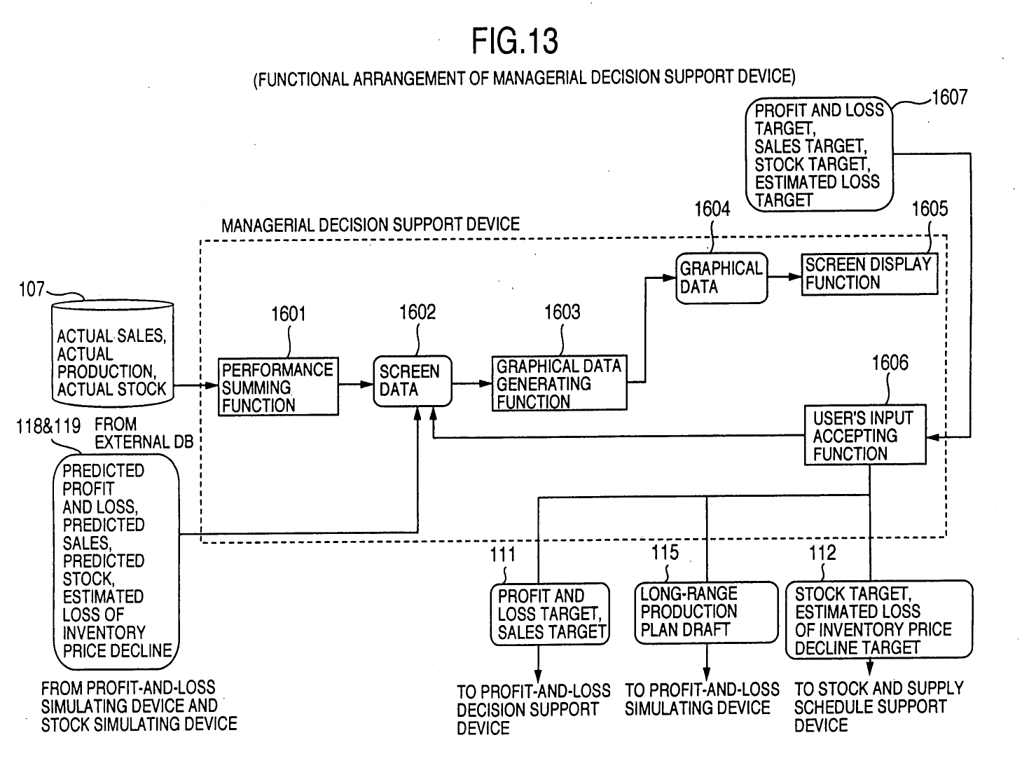

In turn, the process to be executed by the managerial decision support device 101 will be described with reference to FIGS. 13 to 25. FIG. 13 shows the functional arrangement of the managerial decision support device 101 and the protocol of exchanging information among the functions.

A numeral 1601 denotes a performance summing function. A numeral 1602 denotes screen data. A numeral 1603 denotes a graphical data generating function. A numeral 1604 denotes graphical data. A numeral 1605 denotes a screen display function. A numeral 1606 denotes a user input accepting function. A numeral 1607 denotes various kinds of target values specified by the executive.

The performance summing function 1601 is executed to sum up at a summing unit period (such as on a month or week basis) the actual sales, the actual production, and the actual stock 107 registered at an occurrence unit and then to output the values onto the screen data 1602. The graphical data generating function 1603 is executed to generate the graphical data 1604 that is dot-sequential data plotted in the graph. Further, the graphical data generating function 1603 is also executed to extract the inflection points of the graphical data and write their attributes into the graphical data 1604. The screen display function 1605 is executed to display the screens shown in FIGS. 3 to 14 from the graphical data 1504, the profit and loss target, the sales target, and the stock target. The user input accepting function 1606 is executed to change the long-range schedule draft, the profit and loss target, the sales target, and the stock target.

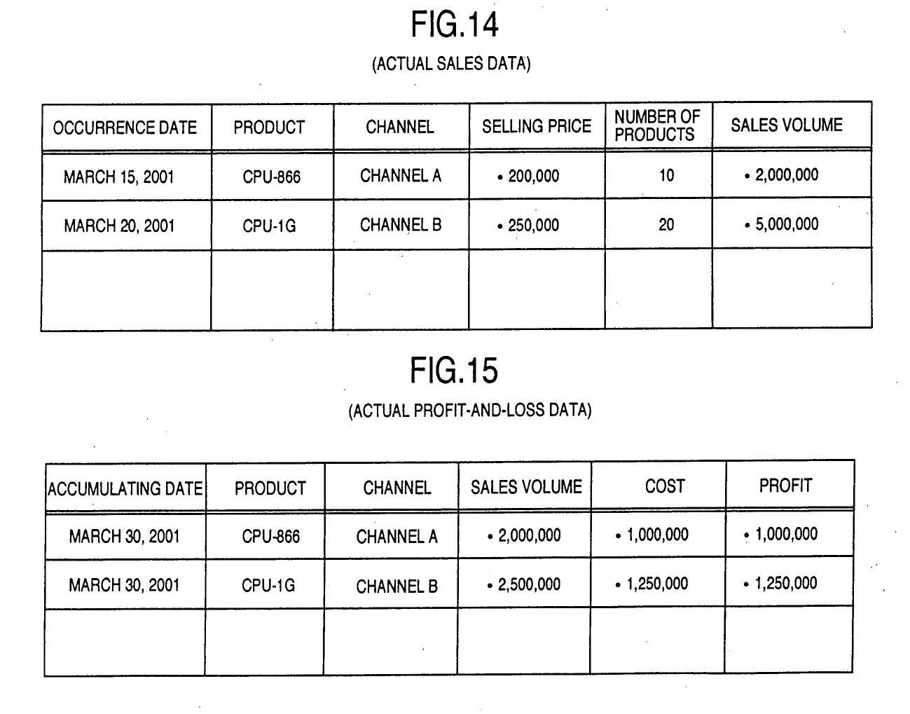

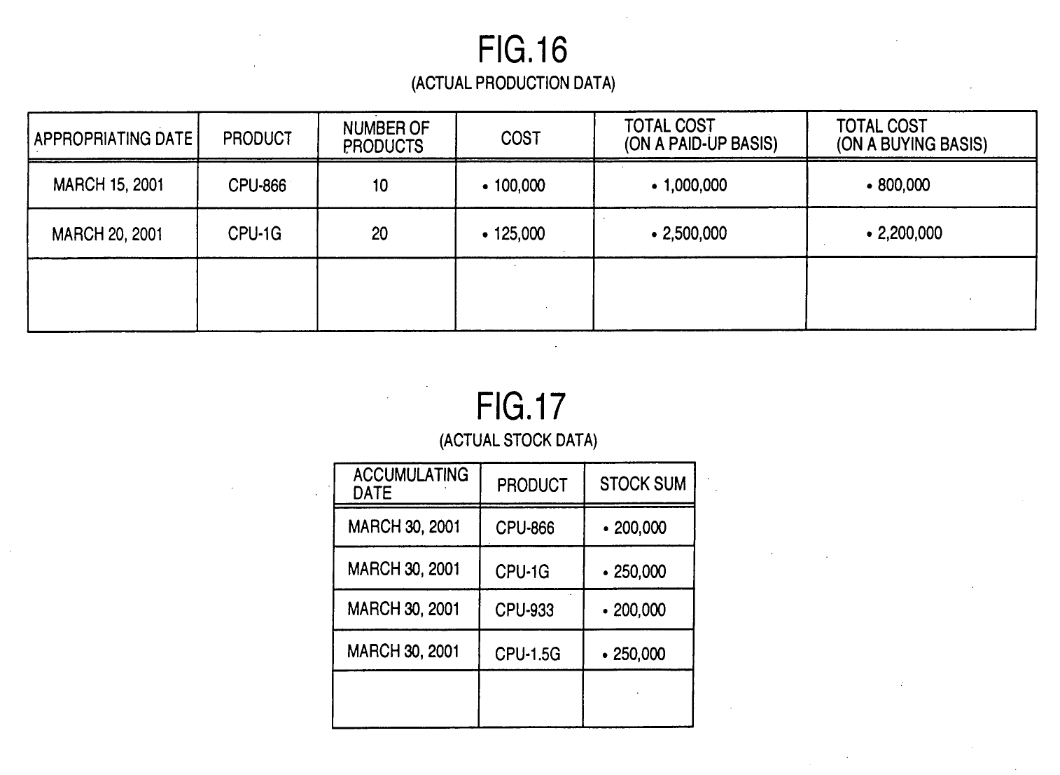

FIGS. 14 to 17 show the details of the actual sales, the actual production, and the actual stock stored in the database 107. FIGS. 14 and 15 show the details of the actual sales stored in the database 107. The actual sales is composed of the actual sales shown in FIG. 14 and the profit and loss performance shown in FIG. 15. As shown in FIG. 14, the actual sales is composed of an occurrence date, a product (product specification), a channel (corresponding to the node of the tree structure shown in FIG. 34), a selling price (unit price), a number of products, and a sales volume at each sale unit. Herein, the product (product specification) means one type of the product types (a lineup of PC products). In this embodiment, each product type is identified by the name of the CPU that is a feature of the product (PC). As shown in FIG. 15, the actual profit and loss is composed of a summing date, a product (product specification), a channel, a sales volume, a cost, and a profit at a unit period where the data is summed (on a month, week or day basis). FIG. 16 shows an example of the actual production. As shown, the actual production data is the data accumulated at each sum of each production lot and is composed of a summing date, a product (product specification), a number of products, a cost, and a total cost. FIG. 17 shows the details of the actual stock. As shown, the actual stock is summed on a summing day basis or at a product unit.

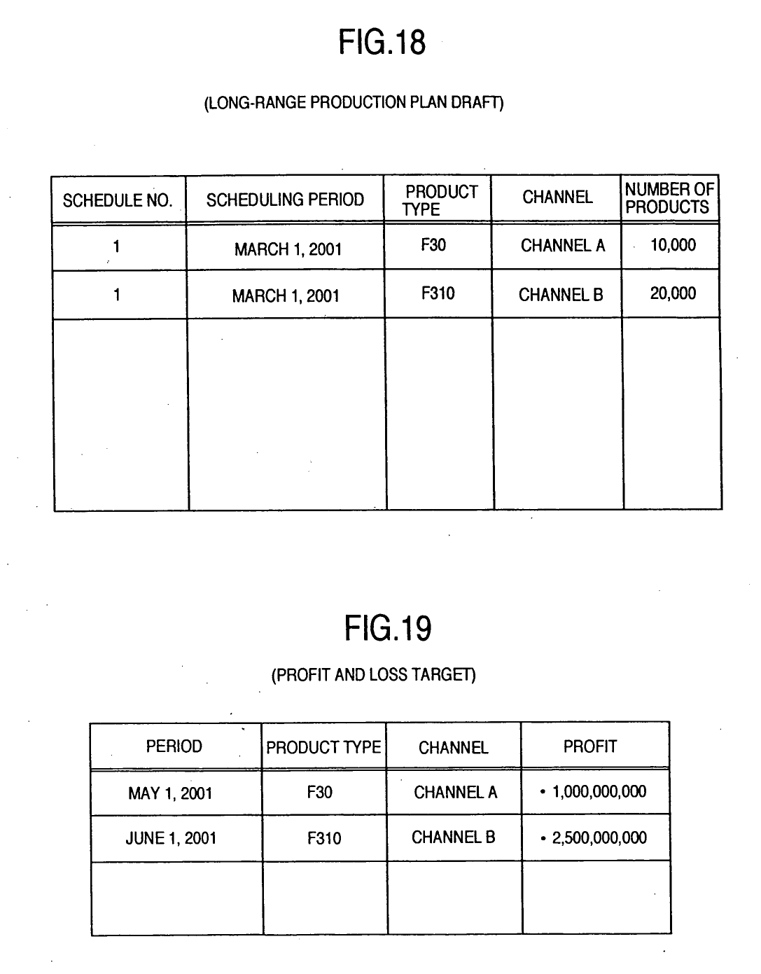

FIGS. 18 to 22 show the details of the long-range schedule draft, the profit and loss target, the sales target, the stock target, and the estimated loss target that are the data to be edited by the user input accepting function 1606.

FIG. 18 shows an example of the long-range schedule draft. The long-range schedule draft is composed of a schedule number, a planning period (for example, Mar. 1, 2001 to Mar. 31, 2001), a product type, a channel, and a number of products. Herein, the planning period is one month. It may be summed up to half a year. The schedule number is information on which a plurality of schedule drafts are distinguished into a new one or an amended one.

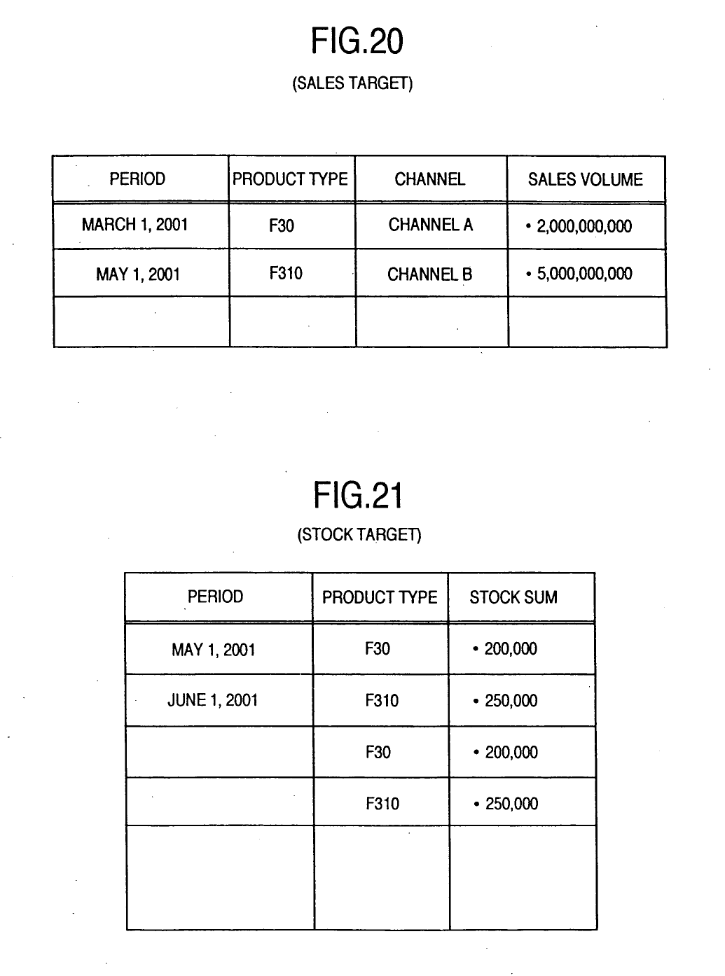

FIG. 19 shows an example of the profit and loss target data. The profit and loss target data is composed of a target period, a product type, a channel, and a profit. FIG. 20 shows an example of the sales target data. The sales target is composed of a target period, a product type, a channel, and a sales volume. FIG. 21 shows an example of the stock target data. The stock target data is composed of a target period, a product type, and a stock sum.

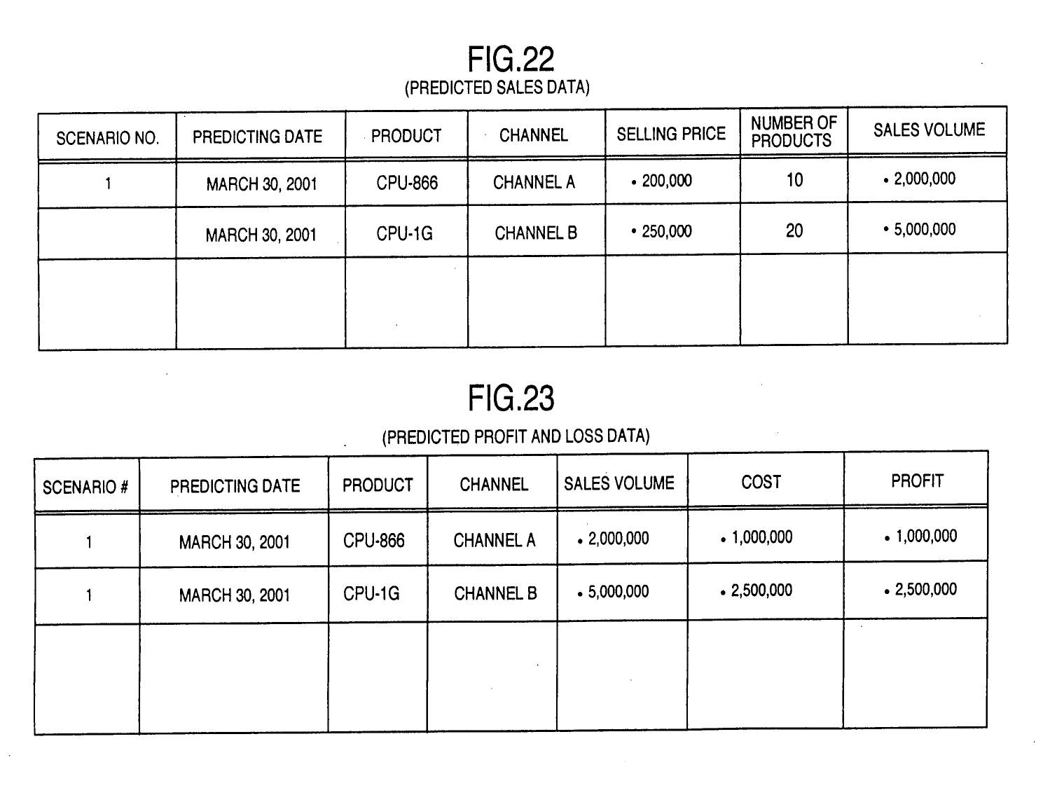

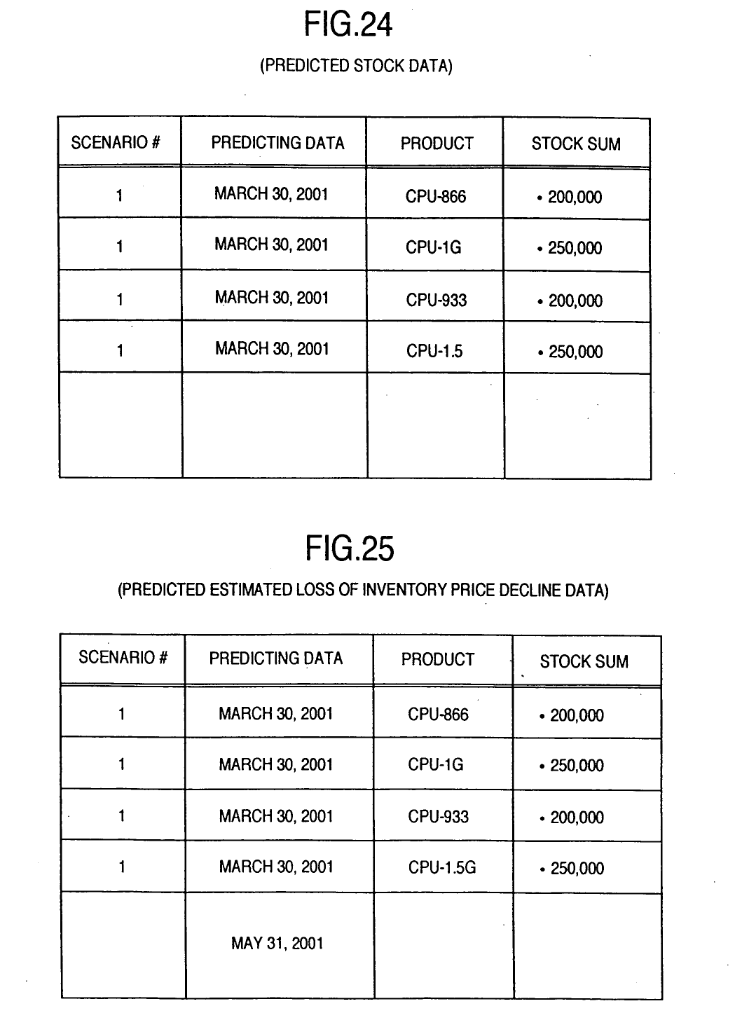

The sales prediction and the profit and loss prediction denoted by 118 and the stock prediction denoted by 119 will be described with reference to FIGS. 22 to 25. FIG. 22 shows an example of the sales prediction data. As shown, the sales prediction data is composed of a prediction date, a product (product specification), a channel, a selling price, a number of products, and a sales volume. The prediction data represents a time when the prediction is to be carried out in future. FIG. 23 shows an example of the profit and loss prediction data. As shown, the profit and loss prediction data is composed of a prediction date, a product (product specification), a channel, a sales volume, a cost, and a profit. FIG. 24 shows an example of the stock prediction data. As shown, the stock prediction data is composed of a prediction date, a product (product specification), and a stock sum.

As described above, according to this embodiment, the managerial decision support device 101 is arranged as shown in FIG. 13 so that the useful measures for the managerial decision may be displayed in a graphical manner. Further, the managerial decision support device 101 may quickly and properly supply the executive with the managerial measures in concert with another profit-and-loss simulating device 103 and the stock simulating device 105.

The foregoing embodiment has been described on the assumption that the managerial decision support device 101, the profit-and-loss decision support device 102, the profit-and-loss simulating device 102, the supply schedule draft device 104, the sock simulating device 105, and the stock and supply schedule support device 106 are located within one enterprise site. It is not limited to this arrangement. It may be an associated system spreading over a plurality of enterprises. For example, the managerial decision support device 101 is a system owned by the A company. The other devices are owned by the contract manufacturing service company B and the logistics managing company C. The transfer of information among the devices is executed over the network so that the managerial decision support may be realized over a plurality of companies. Instead, the managerial decision support device 101, the profit-and-loss decision support device 102, and the stock supply schedule support device 106 may be owned by the same enterprise or a plurality of enterprises, while the profit-and-loss simulating device 103, the supply schedule draft device 104, and the stock simulating device 105 may be owned by the simulation service providing company D (ASP: Application Service Provider). In this arrangement, the enterprise side may be supplied with the managerial decision support service (simulation service) only if it merely owns the hardware for operating the GUI function. The ASP side may be supplied with the price for the supplied service.

In turn, the description will be oriented to the second embodiment of the present invention.

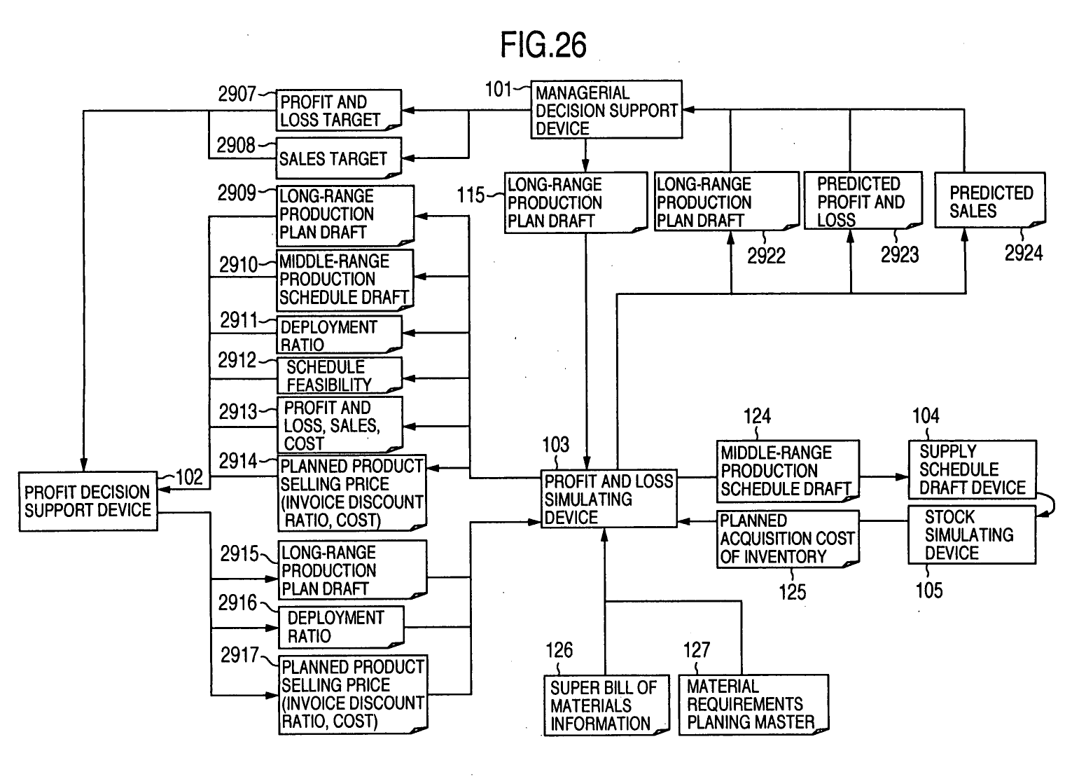

FIG. 26 is an explanatory view for illustrating various kinds of informations and the association of the devices included in the profit-and-loss decision support system according to the present embodiment. In FIG. 26, the same components as those in FIG. 1 have the same reference numbers. If the same component is divided into parts, each part is given a new number.

A numeral 2907 denotes information about a profit and loss target. A numeral 2908 denotes information about sales target. A numeral 2909 denotes information about a long-range schedule draft outputted by the profit-and-loss simulating device 103. A numeral 2910 denotes information about a middle-range schedule draft. A numeral 2911 denotes information about a distribution ratio. A numeral 2912 denotes information about a schedule feasibility. A numeral 2913 denotes information about a profit and loss, sales and a cost. A numeral 2914 denotes information about a planned product price (invoice discount ratio, cost). A numeral 2915 denotes information about a long-range schedule modified by the sales and production managers. A numeral 2922 denotes information about a long-range schedule draft outputted by the profit-and-loss simulating device 103 to the managerial decision support device 101. A numeral 2933 denotes information about a predicted profit and loss. A numeral 2924 denotes information about predicted sales.

As shown in FIG. 26, the profit-and-loss decision support system according to the second embodiment is arranged to have the managerial decision support device 101 for generating various kinds of managerial measures and the long-range schedule draft, the profit-and-loss simulating device 102 for expanding the long-range schedule draft generated by the managerial decision support device 101 into the middle-range schedule draft and then calculating and holding the profit-and-loss information, and the profit-and-loss decision support device 103 for changing various kinds of information as referring to the information held in the profit-and-loss simulating device 102 (installed on the side of the sales and production manager) and the profit and loss target and the sales target supplied by the managerial decision support device 101.

The profit-and-loss decision support device 103 is arranged as a device with a Web site or a browser so that the device 103 may be accessed for inputting the held information into the terminal located on the side of each decision supporter.

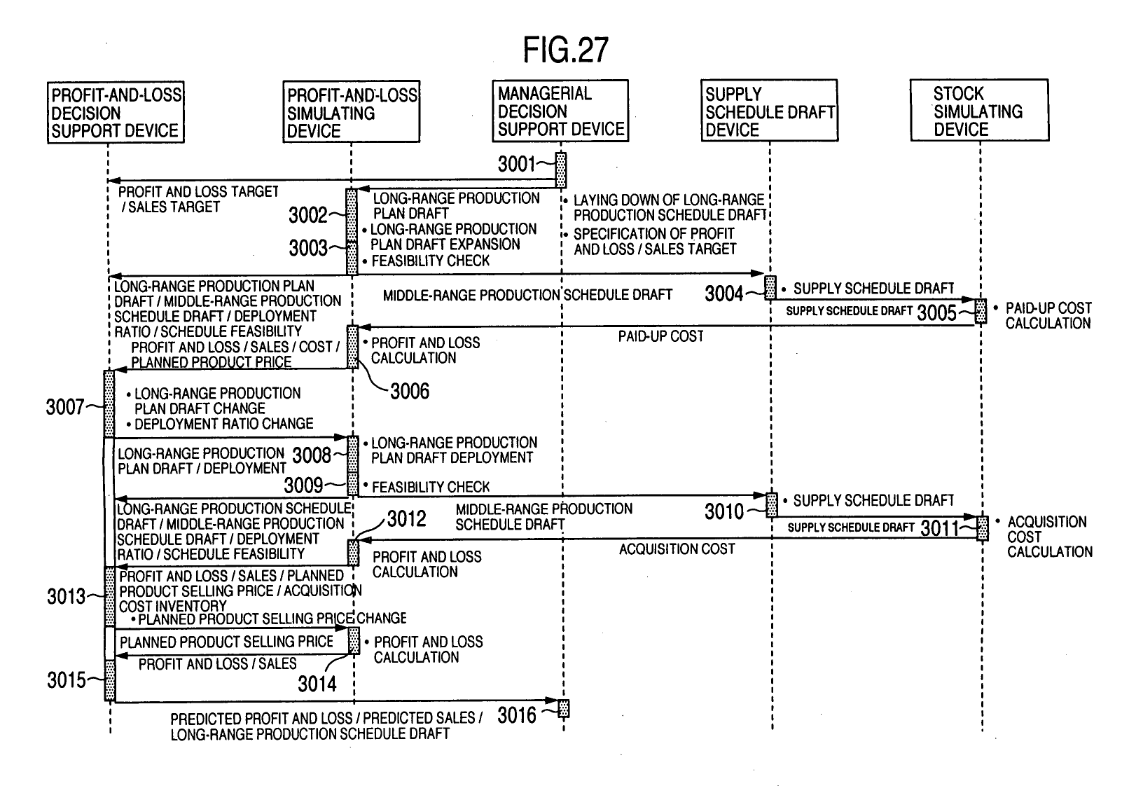

Next, the profit-and-lost decision support system will be described with reference to the sequence view of FIG. 27.

FIG. 27 is a sequence view showing the process of each device and transfer of information among the devices shown in FIG. 26 in a chronological manner. This corresponds with FIG. 2 of the first embodiment. In FIG. 27, the process S204 shown in FIG. 2 is divided into the process of expanding the long-range schedule draft 3602 and the process of checking a feasibility. The process S207 in FIG. 2 is divided into the process of expanding the long-range schedule draft 3008 and the process of checking a feasibility 3009. The different respect of FIG. 27 from FIG. 2 is these divisions.

The new long-range schedule draft 1115 drafted by the managerial decision support device 101 is provided to and held in the profit-and-loss simulating device 103. At a time, the profit and loss target 2907 and the sales target 2908 are provided to and held in the profit-and-loss decision support device 102.

The profit-and-loss simulating device 103 having accepted the new long-range schedule draft 115 expands the new long-range schedule draft for creating the new middle-range schedule draft (124, 2910) through the effect of the long-range schedule expanding function 3602.

Afterwards, the feasibility checking function 3003 is executed to check if the new middle-range schedule draft is feasible. The created schedule feasibility information 2912, the new long-range schedule draft 2909, the middle-range schedule draft 2910, and the deployment ratio 2911 are transferred to and held in the profit-and-loss decision support device.

The profit-and-loss decision support device, having accepted the information about the profit and loss and the sales, operates to display on screen the information by using the schedule feasibility information 2912, the new long-range schedule draft 2909, the new middle-range schedule draft 2910, the deployment ratio 2911, and the super bill of materials 126 represented in a tree structure. One example of the display is shown in FIG. 34.

Further, the values of those informations may be changed by the long-range schedule changing function and the deployment ratio changing function included in the profit-and-loss decision support device 102. The changed long-range schedule draft 2915 and the changed deployment ratio 2916 are transferred to the profit-and-loss simulation and are again deployed through the long-range schedule deployment function 3008 and the feasibility checking function 3009.

The created schedule feasibility information 2912, the changed long-range schedule draft 2909, the changed middle-range schedule draft 2910, and the changed deployment ratio 2911 are all transferred to and held in the profit-and-loss decision support device 102.

At a time, the middle-range schedule draft 124 amended by the change of the long-range schedule draft is transferred to the supply schedule draft device 104. The supply schedule draft device 104 operates to create a new supply schedule draft based on the amended middle-range schedule draft 124 through the effect of the supply schedule draft function 3010.

The profit-and-loss simulating device 103 operates to re-calculate a profit and loss based on the amended middle-range schedule and the planned product price through the effect of the profit-and-loss calculating function 3012. The profit and loss, sales, and cost 2913, and planned product price 2914, derived by the device 103, are all supplied to the profit-and-loss decision support device 102.

Further, the planned product price may be also changed by using the planned product price change function 3013 included in the profit-and-loss decision support device. In this case, the amended planned product price 3017 is transferred to the profit-and-loss simulating device 103. Then, about the price 3017, the profit and loss is calculated by using the profit-and-loss calculating function 3014 included in the profit-and-loss simulating device 103. The calculated profit and loss is again transferred to the profit-and-loss decision support device 102. The profit and loss is displayed on screen through the effect of the display function. FIG. 27 illustrates the long-range schedule change function, the deployment ratio change function 207, and the planned product price change function 3013 separately. The separate illustration is for the convenience's sake because each process after change is independent. These functions may be combined as one change function.

The repetition of these simulations results in creating a feasible long-range-schedule draft that meets the request of the sales and production manager. Then, the operation of the profit-and-loss decision support device 102 is terminated (3015). The predicted profit and loss information 2923, the predicted sales information 2924, and the amended long-range schedule draft 2922 are transferred to the managerial decision support device 101. Then, the series of processes are terminated.

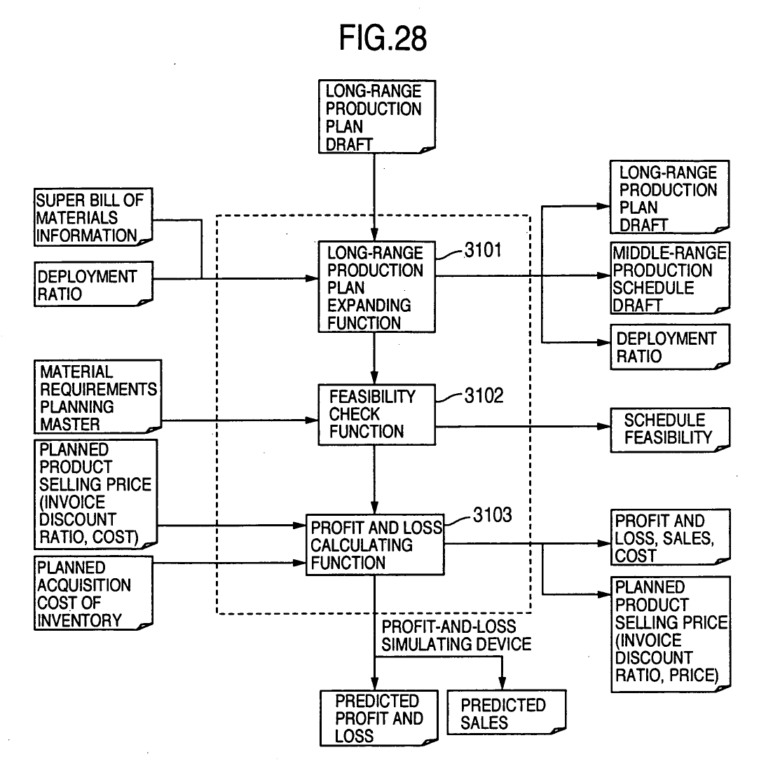

FIG. 28 is an explanatory view showing the arrangement and the I/O information of the profit-and-loss simulating device 103.

The profit-and-loss simulating device 103 is composed of a long-range schedule deploying function 3101, a feasibility check function 3102, and a profit-and-loss calculating function 3103. The information to be inputted into the profit-and-loss simulating device 103 includes a long-range schedule draft, a super bill of material, a deployment ratio, a required amount calculating master, a planned product price (an accounts ratio and a price), and a planned acquisition cost of inventory, all of which are shown in the left hand of FIG. 28. The information to be outputted to the device 103 includes a long-range schedule draft, a middle-range schedule draft, a deployment ratio, a schedule feasibility, a profit and loss, sales, cost information, and a planned product cost (an invoice discount ratio and a price).

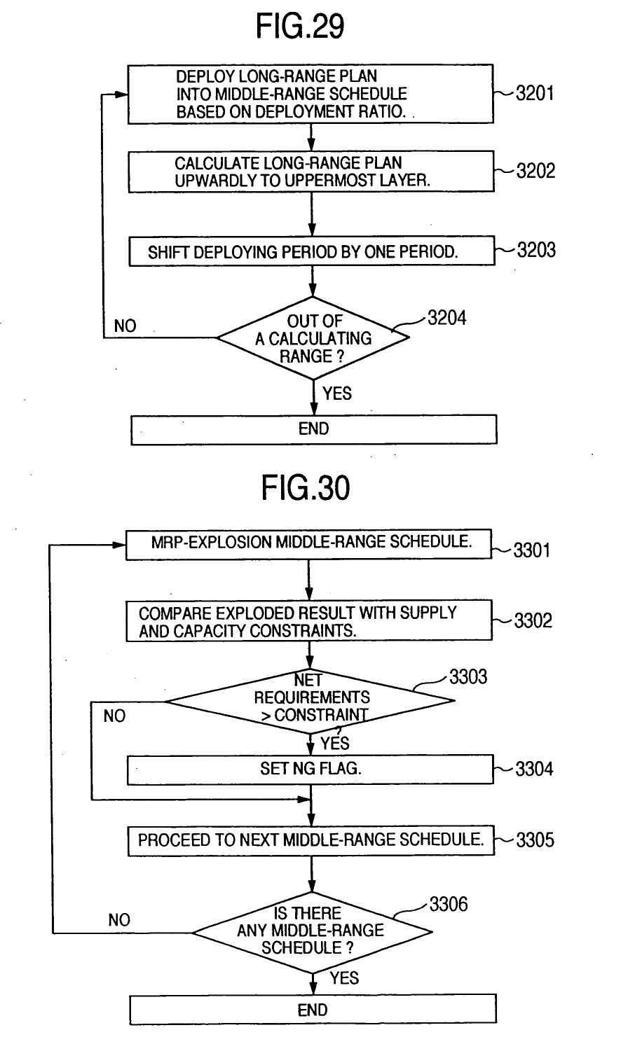

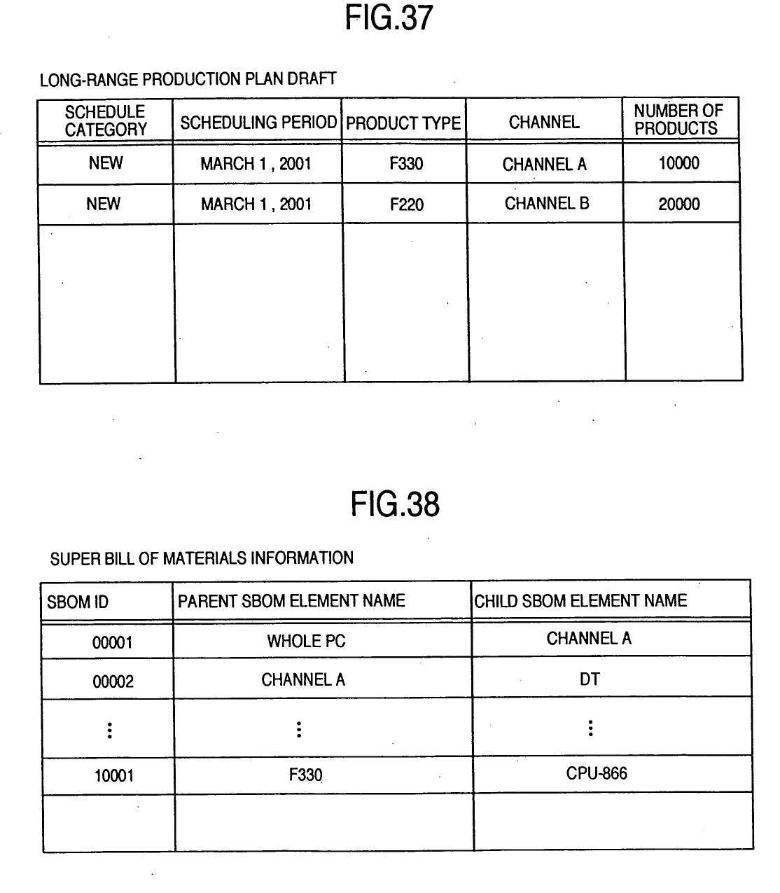

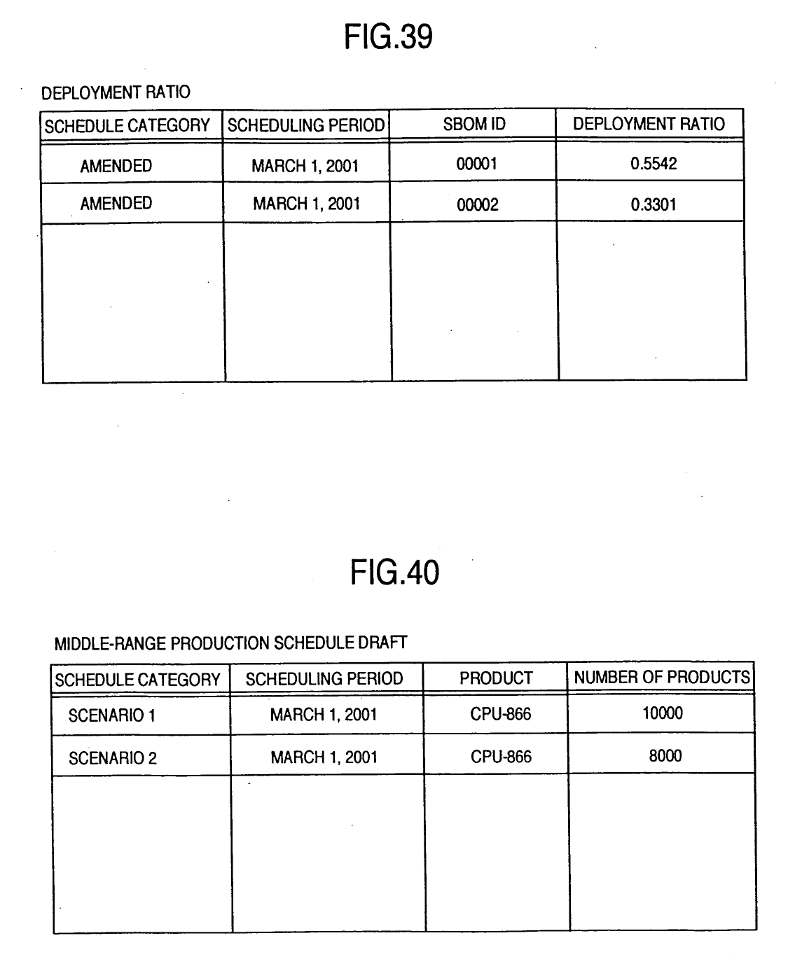

In turn, the description will be oriented to the input and output of the long-range schedule deploying function 3101, which is shown in FIG. 37. The long-range schedule draft are planned values including a schedule section, a planned period (on a month basis), a product type, a channel, and a number of products. The information to be inputted to the long-range schedule deploying function 3101 includes the super bill of materials information 126 and the deployment ratio information. The super bill of materials information 126 is shown in FIG. 38 and includes a Super Bill Of Material (SBOM ID) ID, a parent SBOM element, and a child SBOM element. These pieces of information are required for creating a product tree. The deployment ratio information is shown in FIG. 42 and includes a planned period (on a month basis), a SBOM ID, and a deployment ratio, all of which are used when deploying the schedule. The information to be outputted from the long-range schedule deploying function 3101 includes the middle-range schedule draft, the long-range schedule draft, and the deployment ratio. The middle-range schedule draft is as shown in FIG. 40 and is the detailed planned values composed of a planned period (on a month basis), a product name (part name), and a number of products. The long-range schedule draft has the same format as the inputted information. The deployment ratio is shown in FIG. 39 and is composed of a schedule section, a planned period, a SBOM ID, and a deployment ratio. The long-range schedule deploying function will be described with reference to FIG. 29.

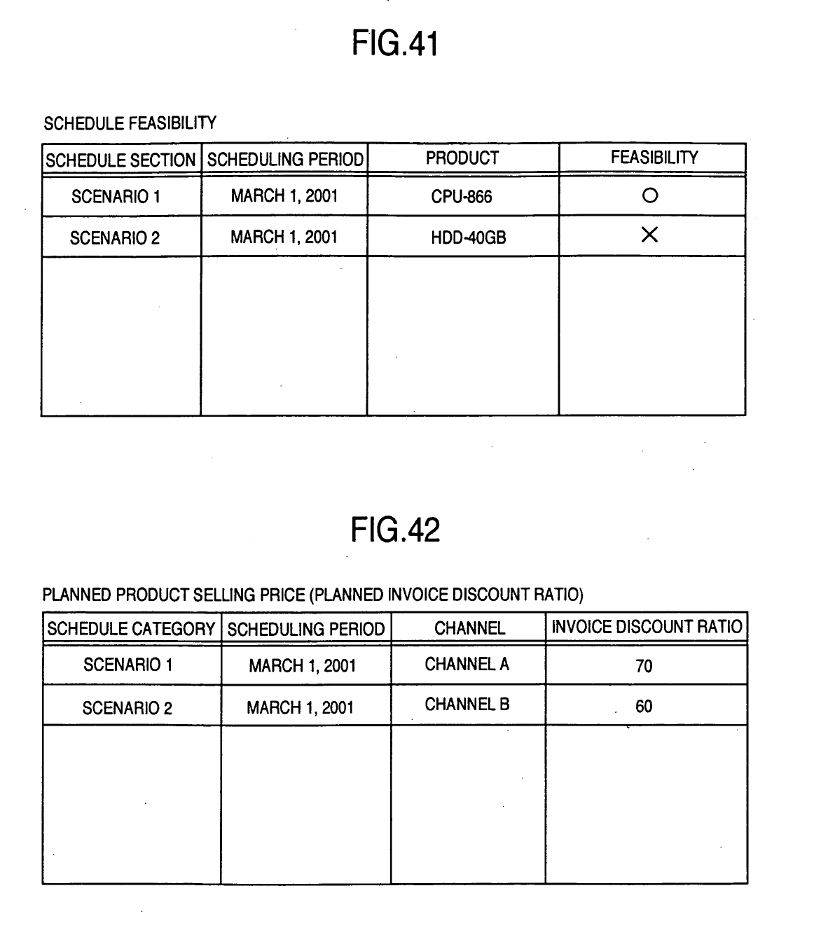

The description will be oriented to the input and output of the feasibility check function 3102. The information to be inputted to the feasibility check function 3102 includes the required amount calculating master 127 and the middle-range schedule draft. The required amount calculating master 127 is the master information required for calculating a required amount. The middle-range schedule draft is the information to be outputted from the long-range schedule deploying function. The output is the schedule feasibility information. The schedule item feasibility information is composed of a schedule section, a planned period, a product name, and a feasibility as shown in FIG. 41. The process of checking a feasibility will be described with reference to FIG. 30.

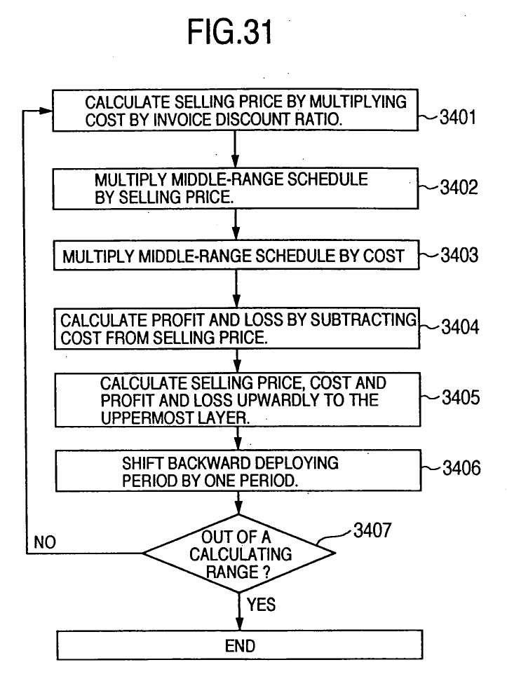

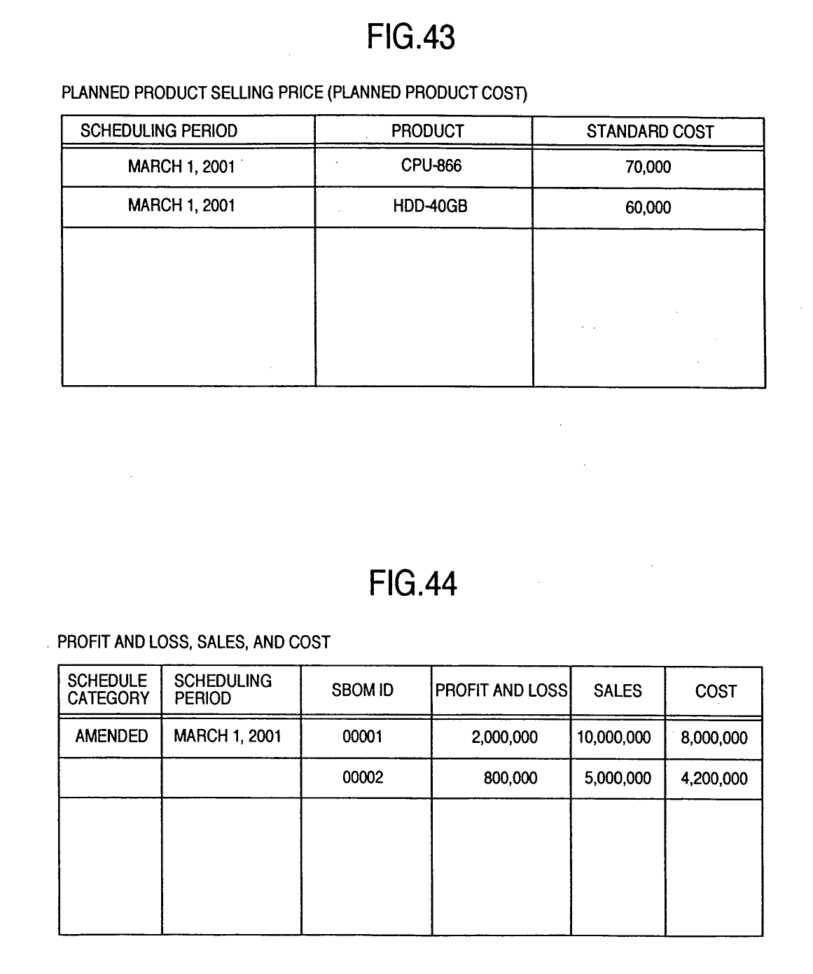

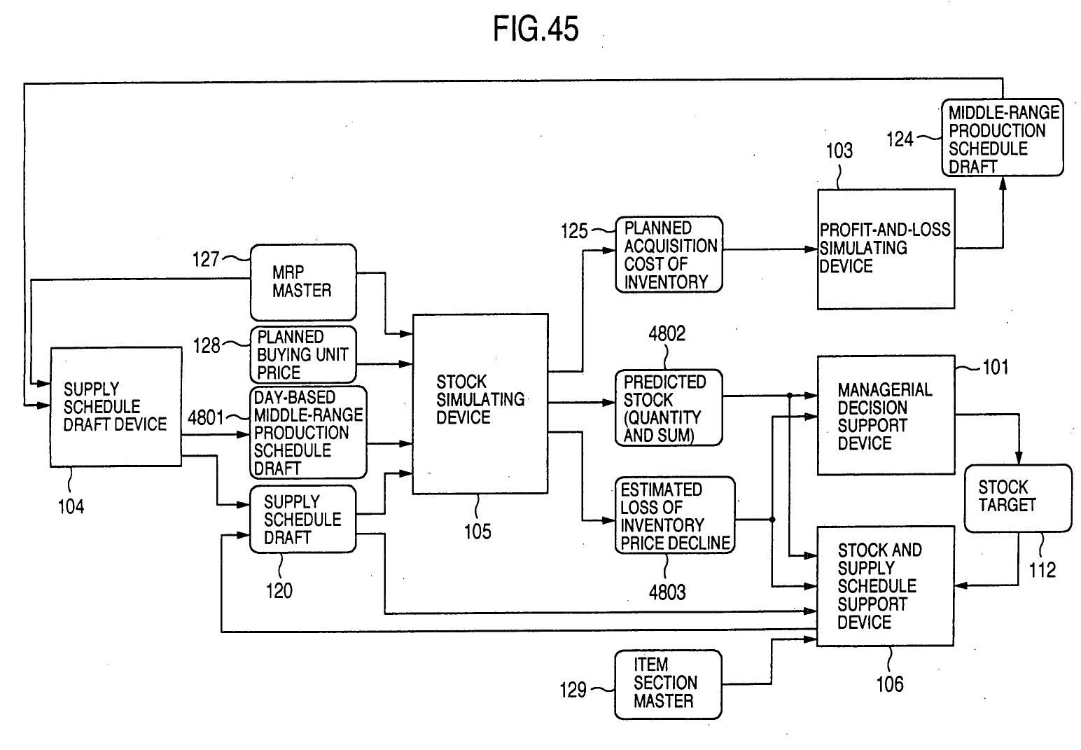

The information to be inputted to the profit-and-loss calculating function 3103 includes the planned product price (planned accounts ratio), the planned product price, the long-range schedule draft, the super bill of material, and the deployment ratio. The planned product price (planned invoice discount ratio) includes a planned period, channel information, and the invoice discount ratio as shown in FIG. 45. The planned product price includes the planned period, the product, and standard price information as shown in FIG. 43. The long-range schedule draft, the super bill of materials information, and the deployment ratio are outputted to the long-range schedule deploying function 3101. The information to be outputted from the profit-and-loss calculating function 3103 is the information about a profit and loss, sales and a cost. The information includes a schedule section, a planned period, a SBOM ID, profit-and-loss information, sales information, and cost information as shown in FIG. 44. The profit-and-loss calculating function is composed of the process described with reference to FIG. 31.

In turn, the process of deploying the long-range schedule will be described with reference to FIG. 29.

In a step 3201, the process is executed to deploy the long-range schedule draft according to the deployment ratio, based on the super bill of material information 126, for calculating the middle-range schedule draft.

In a step 3202, the process is executed to calculate the long-range schedule draft at the product type level like F330 upwardly to the upper layer, based on the super bill of material information. The upward upward calculation results in summing up the sales of F30, F310 and F330, for example and thereby calculating the profit and loss of the upper product format level (DT: Desktop) (see FIG. 34).

In a step 3203, the period at which the deployment is executed (referred to as an deploying period) is shifted backward by one period.

In a step 3204, it is checked if the period at which calculation is executed (referred to as a calculating period) is out of a calculating range. If not, the process goes back to the step 3201 in which the process is continued. If it is out of the calculating range, the process of deploying the long-range schedule is terminated.

In turn, the process of checking a feasibility will be described with reference to FIG. 30.

In a step 3301, the process is executed to calculate the required amount of materials from the middle-range schedule draft through the use of the known method of calculating the required supply amount in consideration of the order unit or the like derived from the required part amount.

In a step 3302, the process is executed to compare the required amount of materials deployed in the step 3301 with the supply constraint and the capacity constraint. If the required amount is smaller than the constraint in the step 3303, the process goes to the step 3905. If the required amount is greater than the constraint, in a step 3304, the process is executed to set an NG flag to the feasibility column of the feasibility information, and then the process goes to a step 3305.

In the step 3305, the middle-range schedule draft to be deployed is shifted backward by one.

In a step 3306, the process is executed to check if there exists any uncalculated middle-range schedule draft. If yes, the process goes back to the step 3301 in which the process is continued. If no, the process of checking the constraint and deploying the schedule draft is terminated.

In turn, the process of calculating a profit and loss will be described with reference to FIG. 31.

In a step 3401, the process is executed to multiply the planned product price by the invoice discount ratio and to calculate the price of each product. In this case, the process is executed to specify the channel information of the tree including a concerned product from the super bill of materials information and to utilize the invoice discount ratio set to the specified channel.

In a step 3402, the price calculated in the step 3401 is multiplied by the number of products in the middle-range schedule, for calculating the total price of the middle-range schedule.

In a step 3403, the planned price is multiplied by the number of products of the middle-range schedule, for calculating the total cost of the middle-range schedule.

In a step 3404, the planned cost is multiplied by the number of products in the middle-range schedule, for calculating the total cost of the middle-range schedule.

In a step 3405, the profit and loss of the middle-range schedule calculated in the step 3404 is calculated upwardly to the uppermost layer, for calculating the profit and loss of the overall super bill of materials tree.

In a step 3406, the deploying period is shifted backward by one period.

In a step 3407, it is checked if the calculating period is out of a calculating range. If yes, the process goes back to the step 3401 in which the process is continued. If no, the process of calculating a profit and loss is terminated.

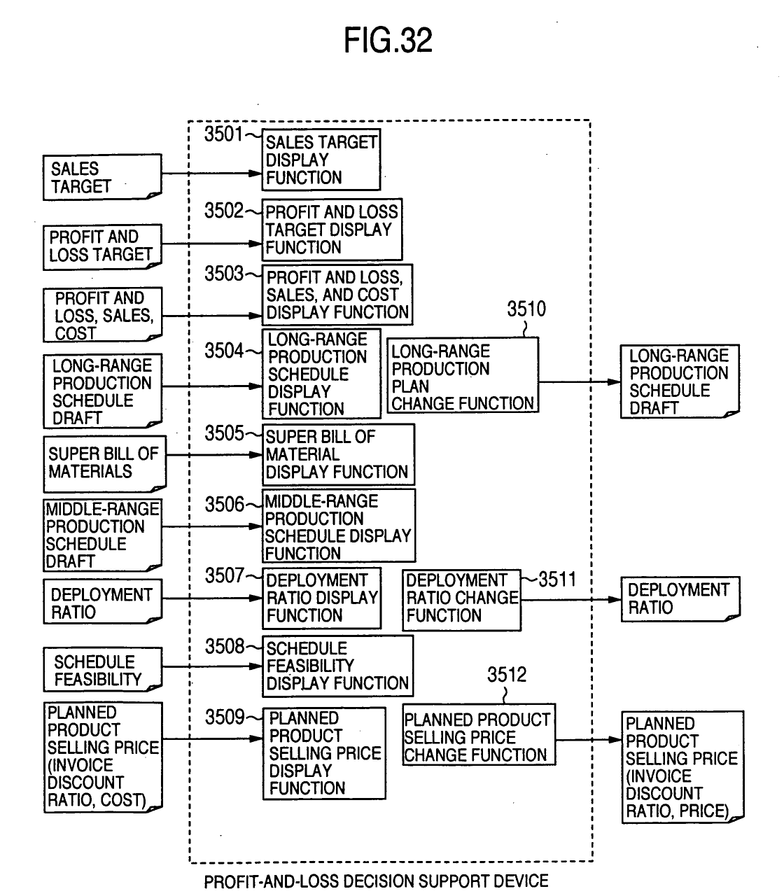

FIG. 32 is an explanatory view showing the functions provided by the profit-and-loss decision support device. A sales target display function 3501 is a function of displaying on screen a sales target provided by the managerial decision support device 101. A profit-and-loss target display function 3502 is a function of displaying a profit and loss target on screen. A profit and loss, sales and cost display function 3503 is a function of displaying on screen a profit and loss, sales and cost, a long-range schedule draft, super bill of materials, a middle-range schedule draft, a deployment ratio, a schedule feasibility, and a planned product price (an accounts ratio and a cost). Moreover, the profit-and-loss decision support device also includes a long-range schedule display function 3504, a super bill of materials display function 3505, a middle-range schedule display function 3506, a deployment ratio display function 3507, a schedule feasibility display function 3508, a planned product price display function 3509, and a long-range schedule change function 3510 of changing the long-range schedule draft, the deployment ratio, and the planned product price on screen, a deployment ratio change function 3511, and a planned product price change function 3512.

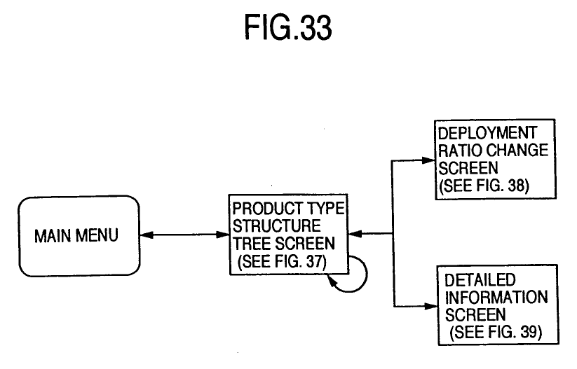

The examples of the user interface screens for realizing each of those functions are shown in FIGS. 34 to 39. The transition view of these screens is shown in FIG. 33.

This screen transition view is used for explaining the transition of the screens displayed on the terminal on the side of the sales and production managers after accessing the profit-and-loss decision support device 102.

As shown in FIG. 33, on a main menu, the start of the profit-and-loss decision support device is selected by a mouse click. Then, the display is transited to the product type structure tree screen of the profit-and-loss decision support device as shown in FIG. 34 (referred to as a product type structure tree screen). On the product type structure tree screen, each kind of information may be displayed and changed. If the information is changed, the information is passed to the profit-and-loss simulating device 103 for re-calculating the information. The recalculated result is passed to the profit-and-loss decision support device 102, which operates to display a new value.

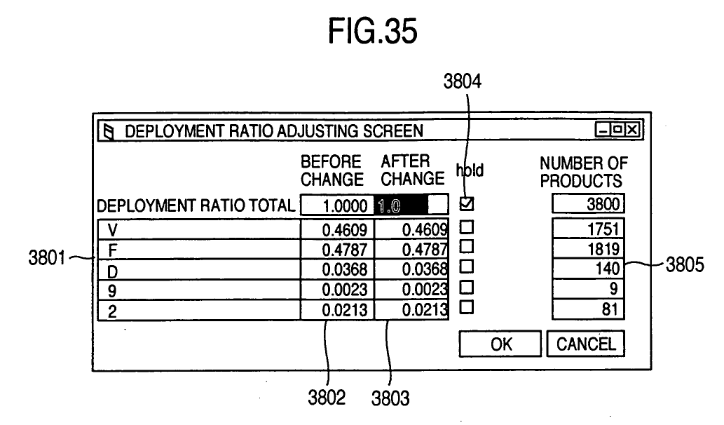

By selecting any one of the components on the product type structure tree screen with a right mouse click, the screen is transited to the deployment ratio change screen as shown in FIG. 35.

Further, by selecting any one of the components on the product type structure tree screen with a left mouse click, the screen is transited to the detailed information screen.

Hereafter, the description will be oriented to the operation of the sales and production manager on the screen displayed on the manager side.

FIG. 34 is a view showing an example of the product type structure tree screen. On the product type structure tree screen, the period to be displayed is selected from the target period select column indicated by 3701. If the period is selected, each kind of information at the target period is displayed on screen.

On the product type structure tree screen, each kind of information may be displayed from the uppermost layer to the lowermost layer along the tree composition in the area 3702 through the use of the long-range schedule draft, the middle-range schedule draft, the planned product price, the deployment ratio, and the schedule feasibility, all of which are supplied by the profit-and-loss simulating device 103, and the sales target, the profit and loss target, and the super bill of materials 126, all of which are supplied by the managerial decision support device 101.

Further, on a tree view screen, an information display field 3704 is prepared in which some pieces of information about each SBOM element 3703 are displayed. In this field is displayed any value selected by the user from the number of products, the deployment ratio, the price, the invoice discount ratio, the profit and loss, the cost, and the schedule feasibility held in the profit-and-loss decision support device 102.

About the long-range schedule draft, the deployment ratio, the planned product price (planned accounts ratio) from the information displayed on the information display field, by positioning a cursor to this display field and rewriting a numerical value on a value to be changed, the information may be changed.

FIG. 35 shows an example of the addition ratio change screen. In the field 3801 are listed the brother components accompanied by a certain parent component. In the column 3802 is displayed the deployment ratio specified for each component. As checking this information, a new value is entered to the field 3803 and the OK button is clicked. This operation promptly causes the changed deployment ratio to be transferred to the profit-and-loss simulating device 103 in which it is re-calculated.

As another process, by clicking a check box 3804, the sum of the addition ratios of all brothers is fixed so that only another value may be changed without changing the addition ratio of a certain component.

The field 3805 displays the number of products. In this field, the number of the corresponding products with the components which are expanded on the changed addition ratios is displayed in advance.

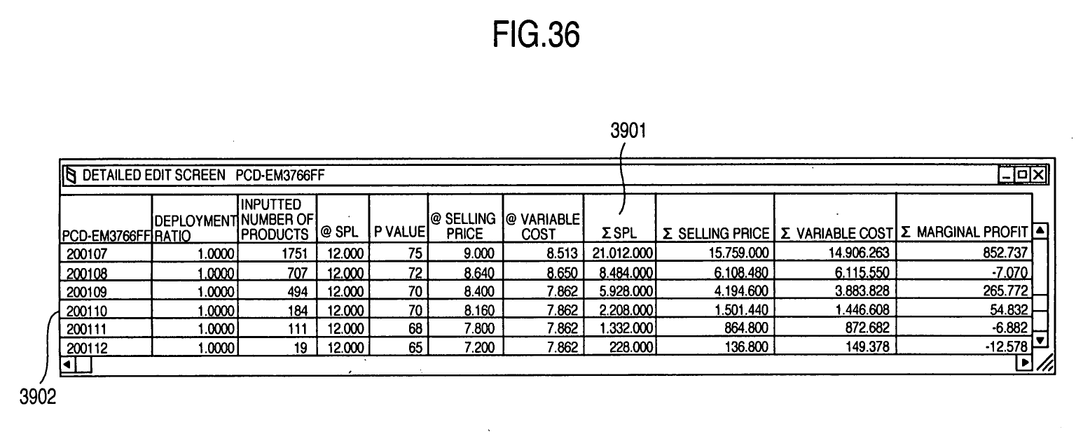

FIG. 36 shows an example of the detailed information screen. On this screen, all information included in a certain component may be displayed in an area 3901. Further, on this screen, as shown in the column 3902, the plans over the preceding periods may be displayed chronologically. Like FIG. 34, also on this screen, the cursor may be positioned to the column in which the information is to be changed, and then a new numerical value may be rewritten on the column. By this operation, the process of changing the information is allowed.

In turn, the description will be oriented to the third embodiment of the present invention.

FIG. 45 is an explanatory view showing the devices and the input and output of the information among the devices in the supply decision support system according to the third embodiment of the invention. In FIG. 45, the common functions to those of FIG. 1 have the same reference numbers. The new reference numbers are given to the different functions and the divided functional parts. A numeral 128 denotes a planned buying price. A numeral 129 denotes an item section master. A numeral 4801 denotes a day-based middle-range schedule draft. A numeral 4802 denotes a predicted stock.

The supply decision support system according to this embodiment and its peripheral system include as their components the supply schedule draft device 104, the stock simulating device 105, the managerial decision support device 101, and the stock and supply schedule support device 106. The supply decision support system includes as its components the supply schedule draft device 104, the stock simulating device 105, and the stock and supply schedule support device 106.

When inputted with the middle-range schedule draft 124 and the required amount master 127, the supply schedule draft device 104 outputs the supply schedule draft 120 and the day-based middle-range schedule draft 4801 drafted on the inputted data. When inputted with the supply schedule draft 120, the day-based middle-range schedule draft 4801, the planned buying price 128, and the required amount calculating master 127, the stock simulating device 105 outputs the predicted stock 4802 calculated on the inputted data. The managerial decision support device 101 displays the inputted predicted stock 4802 and outputs the stock target. The stock and supply schedule support device 106 calculates the predicted stock 4802 and displays it together with the stock target 112. Then, the device 106 accepts the input of changing the supply schedule draft 120 given by the stock and supply schedule manager and then outputs the changed supply schedule draft 120 to the stock simulating device 105.

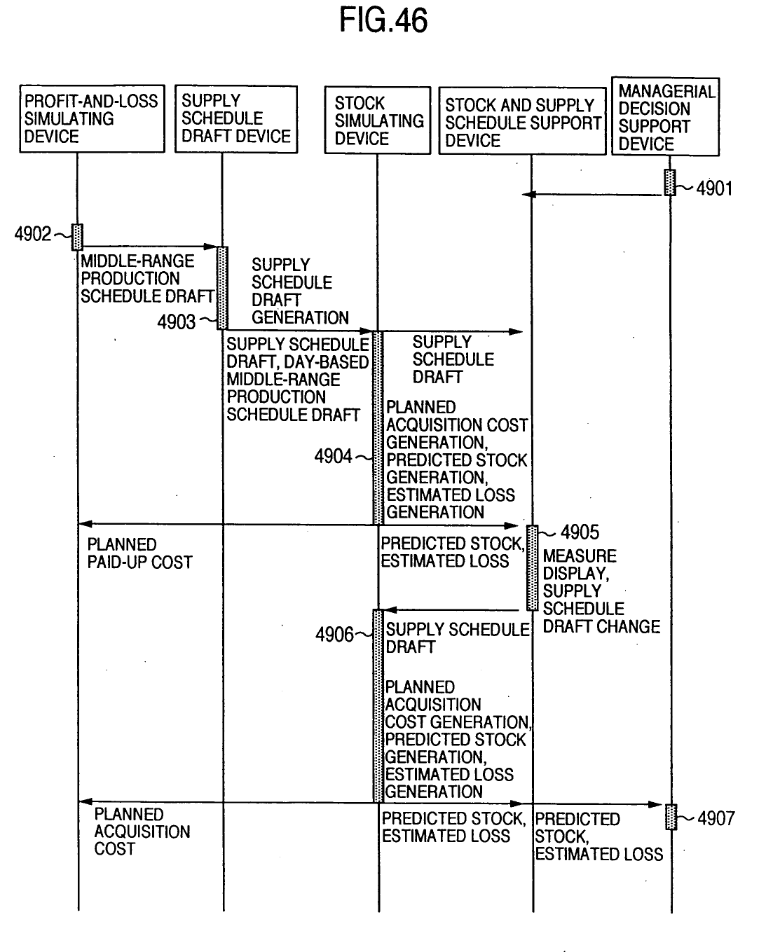

FIG. 46 is a sequence view for describing the process of the supply schedule support device and the flow of the information therein.

At first, the managerial decision support device 101 sends the stock target 112 to the stock and supply schedule support device 106 (step 4901). Then, the profit-and-loss simulating device 103 sends the middle-range schedule draft 124 to the supply schedule draft device 104 (step 4902). In succession, the supply schedule draft device 104 generates the supply schedule draft 120 and then sends the supply schedule draft 120 and the day-based middle-range schedule draft 4801 to the stock simulating device 105 and the supply schedule draft 120 to the stock and supply schedule support device 106 (step 4903). Then, the stock simulating device 105 generates the predicted stock 4802 on the basis of the supply schedule draft 120 sent from the device 104 and then sends the predicted stock 4802 to the stock and supply schedule support device 106 (step 4904). In response, the stock and supply schedule support device 106 displays the inputted measures on screen so that the stock and supply schedule manager may changes the supply schedule draft. The changed supply schedule draft 120 is sent to the stock simulating device 105 (step 4905). The stock simulating device 105 re-calculates the ‘predicted stock 4802’ on the basis of the modified supply schedule draft 120 sent from the device 106, for generating ‘a predicted stock 4802’. ‘The predicted stock 4802’ is sent to the stock and supply schedule support device 106 and the managerial decision support device 101 again (step 4906). The managerial decision support device 101 displays the inputted indexes again (step 4907).

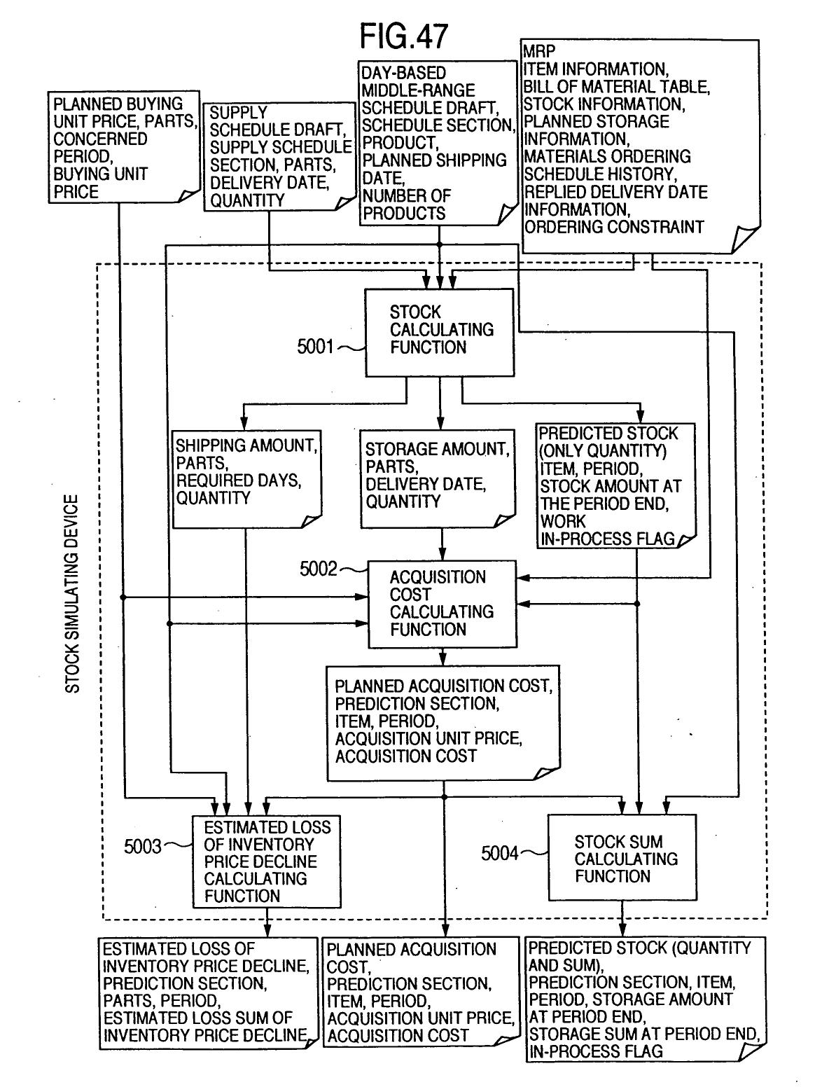

FIG. 47 is an explanatory view for describing the functions and the I/O information of the stock simulating device 105.

The stock simulating device 105 is composed of a stock calculating function 5001 and a stock sum calculating function 5004. The stock simulating device accepts the planned buying price 128, the supply schedule draft 120, the day-based middle-range schedule draft 4801, and the required amount calculating master 127 shown in the uppermost stage from another device. Then, the predicted stock (quantity and sum) 4802 shown in the lowermost stage of FIG. 47 is outputted to another device.

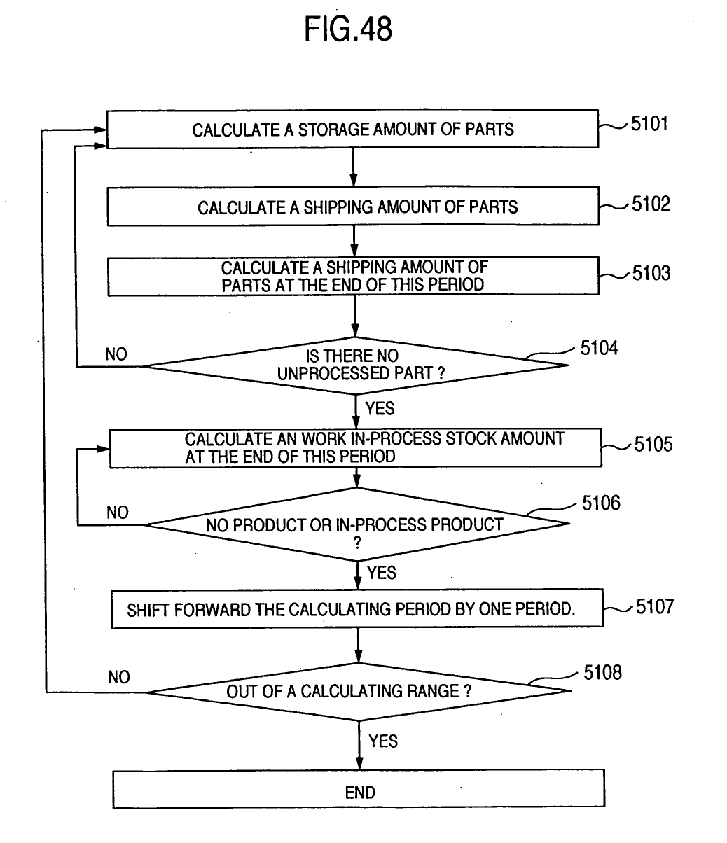

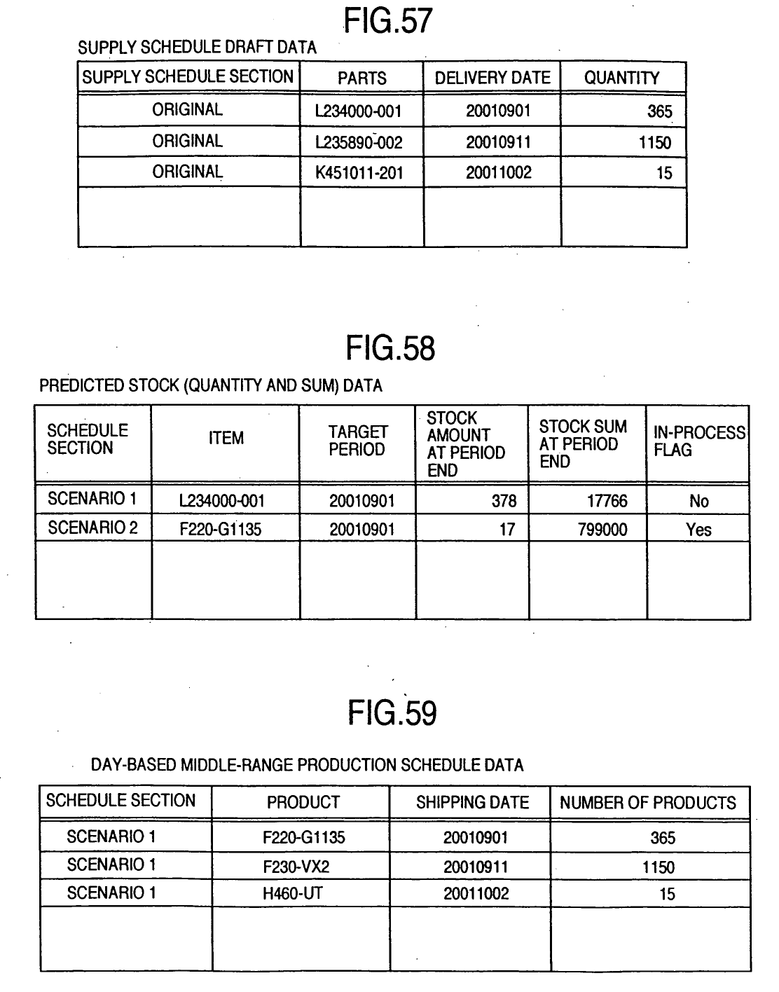

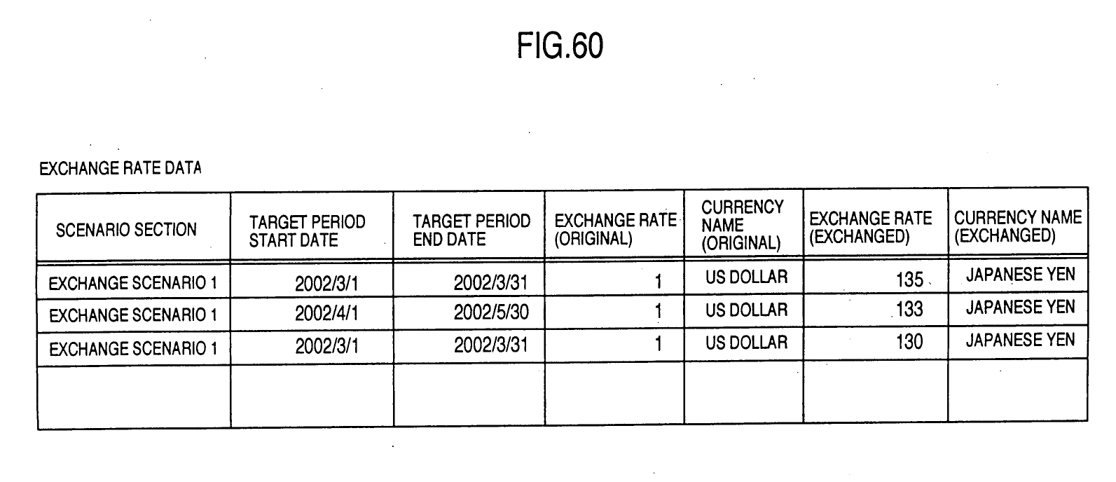

The stock calculating function 5001 is inputted with the stock schedule draft 120, the day-based middle-ranged schedule draft 4801, the day-based middle-ranged schedule draft 4801, and the required amount calculating master 127. As illustrated in FIG. 57, the supply schedule draft 120 is the parts-based supply information composed of parts, supply schedule sections, delivery dates, and quantities. The day-based middle-range schedule draft 480 is the product-based sales information. As shown in FIG. 59, the information includes the items of the product, the schedule category, the shipping date, and the number of products. The required amount calculating master 127 is the information required for calculating the required amount. It has been discussed in detail in the JP-A-2001-266045 titled “the ordering and shipping instructing system”. Then, the stock calculating function 5001 is executed to perform an operation and then output a shipping amount, a storing amount, and a predicted stock (only a quantity). The shipping amount is the information including a part, required date, and a quantity as its items. The storing amount is the information including a part, a delivery date, and a quantity as its items. The predicted stock is the quantity-based stock information having items (a part, a product, and a subassembly), a target period, a stock at the end of the period, and an work-in-process flag as its items. The operation of the stock calculating function 5001 is executed along the process to be described with reference to FIG. 48.

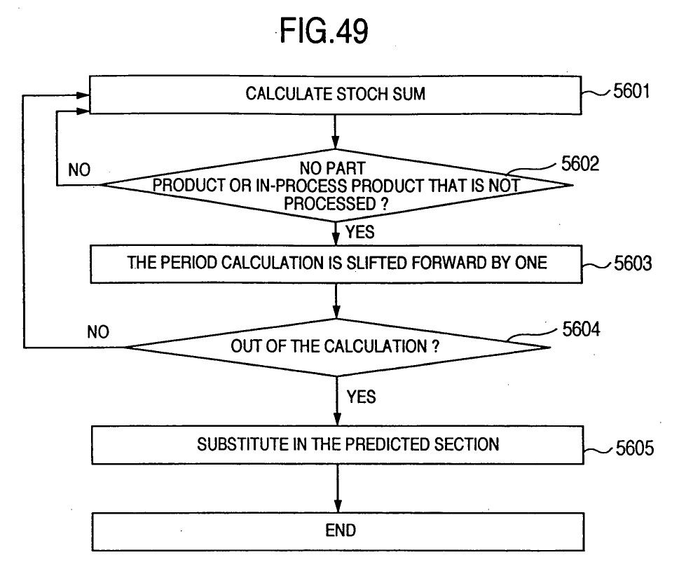

The stock sum calculating function 5004 is inputted with the predicted stock (only a quantity) calculated by the stock calculating function 5001 and calculates the predicted stock (a quantity and a sum). As shown in FIG. 58, the predicted stock (a quantity and a sum) is the stock information having an item, a target period, a stock at the end of the period, a sum of the stock at the end of the period, and an work-in-process flag as its items. The predicted stock (a quantity and a sum) is calculated along the process to be described with reference to FIG. 49.

Herein, the calculating process executed by the stock calculating function 5001 will be described with reference to FIG. 48.

At first, the required supply amount is calculated from the supply schedule draft (step 5101). The calculating method has been described in JP-A-2001-266045 titled “the ordering and shipping instructing system”. This method is executed to calculate the required supply amount as considering the order unit on the required amount of a part. The planned storage amount (backlog) is added to the calculated required supply amount. The added result is specified as a storage amount.

Then, the required amount is calculated from the day-based middle-range schedule draft 4801 and it is specified as a shipping amount (step 5102). The calculating method has been described in JP-A-2001-266045 titled “the ordering and shipping instructing system”. This method is executed to calculate the required amount of a part from the number of schedules on the product level.

Next, about each part, the sum of the storage amount at the concerned period is added to the stock amount at the end of the previous period as indicated in the expression 1. Then, the sum of the shipping amount at the concerned period is subtracted from the added result, for calculating an stock amount at the end of the concerned period (step 5103).

Stocked amount at the end of the concerned period=stock amount at the end of the previous period+Σstorage amount within the concerned period−Σshipping amount within the concerned period (expression 1)

It is checked if the stock amount at the end of the period is calculated about each part. If there exists a part about which it is not calculated, the process goes back to the step 5101 and then process is continued. If there exists no part about which it is not calculated, the process goes to a step 5105 (step 5104).

Then, the process is executed to calculate the stock amount of a product being produced at the last day of the concerned period or the stock amount of an work-in-process product. The target period at which the calculation is to be carried out ranges from the next day of the end day of the concerned period of the product or the work-in-process product to the day when a production lead time has passed since the end of the period. The sum of the planned shipments for this period is specified as the stocked amount of the product or the work-in-process product. It is the stock amount at the end of the period with the work-in-process flag added thereto (step 5105).

Then, it is checked if the stock amount at the end of the period with the work-in-process flag added thereto is calculated about each of all products and work-in-process products. If there exists a product or work in-process product that is not processed, the process goes back to the step 5105 and then the process is continued. If there exists no subassembly or work-in-process, the process goes to a step 5107 (step 5106).

The period at which the calculation is to be done is shifted forward by one (step 5107).

It is checked if the period is out of a calculating range. If not, the process goes back to the step 5101 and then the process is continued. If yes, the stock calculation is terminated (step 5108).

The foregoing operating method is executed to calculate the shipping amount, the storage amount, and the predicted stock (only a quantity).

In turn, the description will be oriented to the calculating process to be executed by the stock sum calculating function 5004 with reference to the flow of FIG. 49.

At first, about each part, the stock sum is calculated by the expression indicated by the expression 4. Further, about each product or subassembly, the stock sum is calculated by the expression 5 (step 5601).

Stock sum=planned unit price×stock amount at the end of the period (expression 4)

Stock sum=planned unit price×stock amount at the end of the period (expression 5)

Then, it is checked if the stock sum is calculated about each of all parts, products, and subassembly. If there exists one part, product or subassembly that is not processed, the process goes back to the step 5601 and then the process is continued. If there exists no part, product or subassembly that is not processed, the process goes to a step 5603 (step 5602).

The period at which the calculation is to be carried out (referred to as a calculating period) is shifted forward by one (step 5603).

It is checked if the calculating period is out of the calculation. If not, the process goes back to the step 5601 and then the process is continued. If yes, the process goes to a step 5605 (step 5604).

Next, the process is executed to substitute the schedule category (a new schedule or a scenario in the amended schedule) in the predicted section of the stock prediction (a quantity and a sum) (step 5605).

The calculation to be executed by the stock sum calculating function 5004 is carried out as described above.

In turn, the description will be oriented to the supply schedule draft device 104.

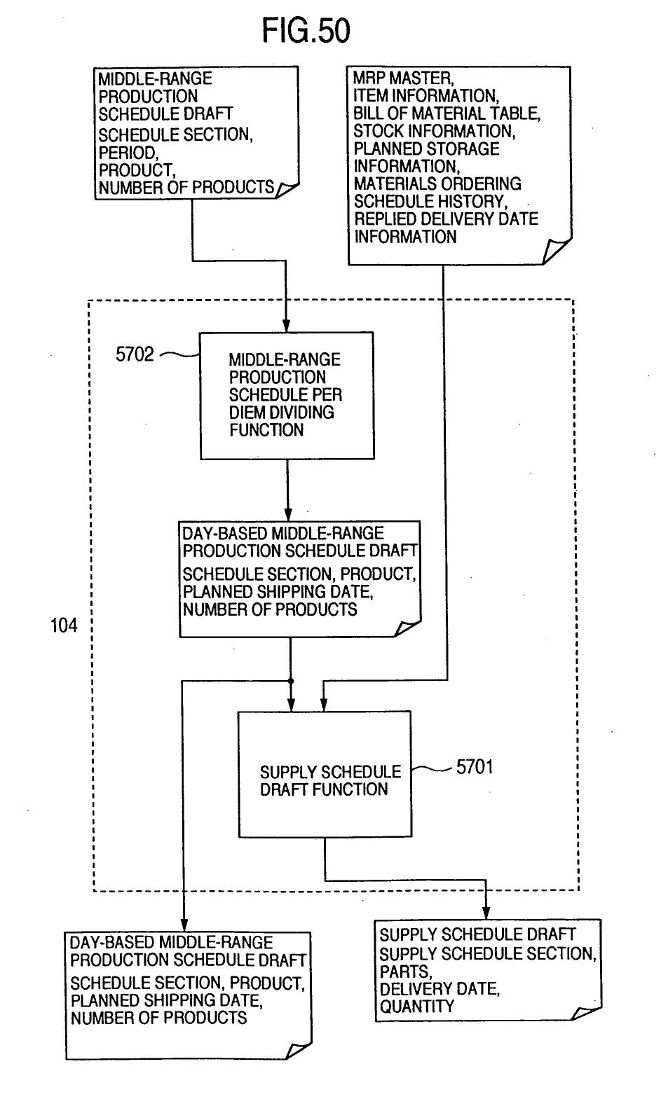

FIG. 50 is a diagram showing the functions and the input and output information of the supply schedule draft device 104. The supply schedule draft device 104 is composed of a supply schedule draft function 5701 and the middle-range schedule per diem dividing function 5702. The supply schedule draft device 104 is inputted with the middle-range schedule draft 125 and the required amount calculating master 129 indicated in the top stage shown in FIG. 50.

The supply schedule draft function 5701 is executed to calculate the supply schedule draft 120 from the day-based middle-range schedule draft 4801 and the required amount calculating master 129. The calculating method has been described in JP-A-2001-266045 titled “the ordering and shipping instructing system”. This calculating method is executed to derive a required amount of a part from the number of schedules on the product level. The supply schedule category at this time is specified as “original”. The term “original” means the first supply schedule automatically calculated by the supply schedule draft device 104 based on the middle-range schedule draft 124 transmitted from the profit-and-loss simulating device 103. On the other hand, if modified by the stock and supply schedule manager, the supply schedule section is specified as “change 1” or “change 2”.

The middle-range schedule per diem dividing function 5702 is inputted with the middle-range schedule draft 125 and is executed to divide each schedule at a unit period of the middle-range schedule draft into the day-based schedules, for calculating the day-based middle-range schedule draft 4801.

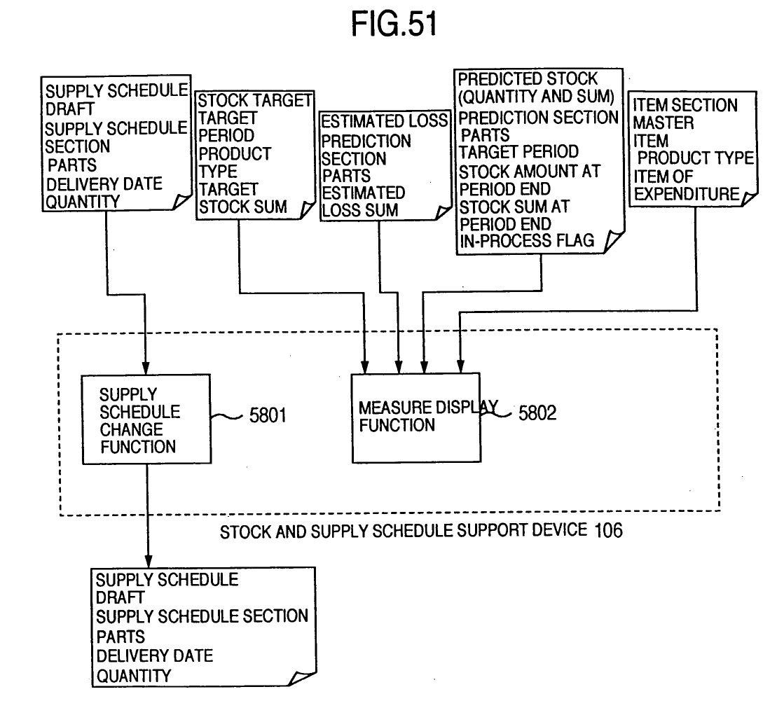

FIG. 51 is an explanatory view for describing the functional arrangement and the input and output information of the stock and supply schedule support device in detail. The stock and supply schedule support device is composed of a supply schedule change function 5801 and an measure display function 5802. The stock and supply schedule support device is inputted with the supply schedule draft 120, the stock target 112, the predicted stock (a quantity and a sum) 4802, and an item category master 129 indicated in the uppermost stage of FIG. 51 from another device. The support device outputs the supply schedule draft 120 indicated in the lowermost stage of FIG. 51.

The supply schedule change function 5801 includes a function of displaying the quantity of the inputted supply schedule draft 120 on an item basis and a delivery-date basis, a function of optionally changing the quantity of the inputted supply schedule draft 120, and a function of revising the supply schedule about an item to be changed.

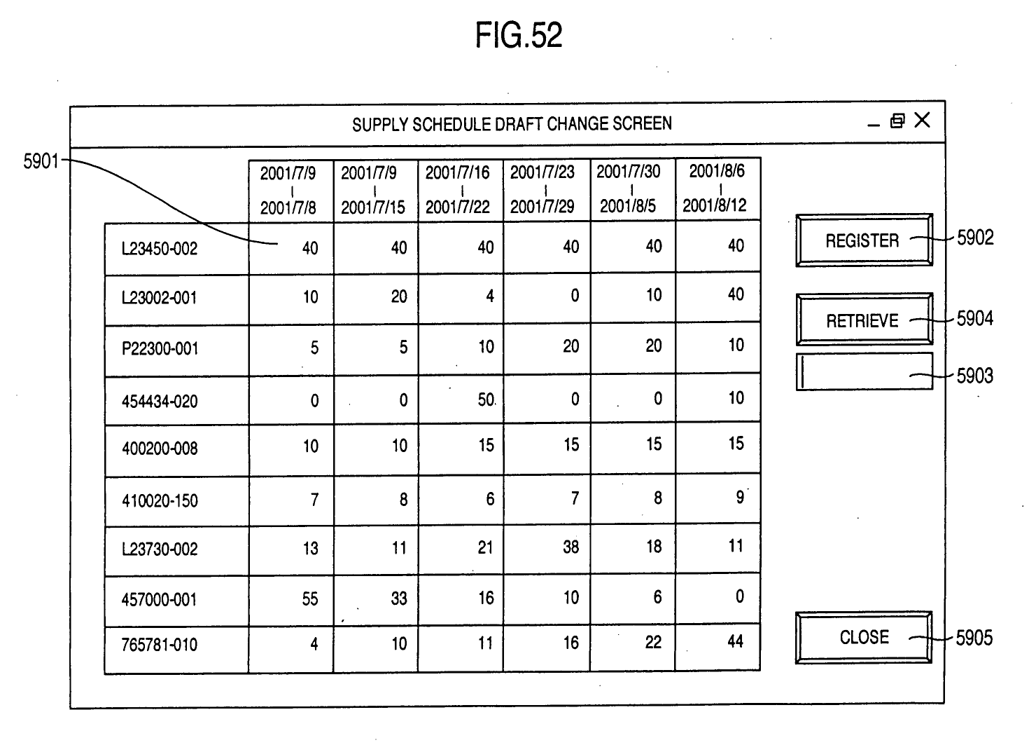

FIG. 52 shows an example of a display of the supply schedule change function on screen.

In FIG. 52, a numeral 5901 denotes a supply schedule display and input unit. This unit operates to display the quantity of the supply schedule draft 120 on an item basis (in the vertical direction of the table) and on a delivery-date basis (in the horizontal direction of the table) and allows the user to enter the quantity in the field for changing the quantity of the supply draft schedule. A numeral 5902 denotes a supply schedule registering button. By clicking this button, the supply schedule category of the supply schedule draft is specified as the “change 1” or the like. A numeral 5903 denotes a retrieval input unit, which is inputted with the name or the code of an item to be retrieved. A numeral 5904 denotes a retrieval button. By clicking this button, the retrieval of the item name or the item code inputted into the retrieval input unit is executed by the known method. A numeral 5905 denotes an end button. By clicking this button, the supply schedule change function is terminated. The person who would change the supply schedule, such as a stock and supply schedule manager, enters the item name or the item code in the retrieval input unit 5903. Then, the person clicks the retrieval button 5904. Then, he or she enters in the field the quantity of the supply schedule of the item retrieved and displayed in the supply schedule display and input unit, for rewriting the quantity. Then, by clicking the supply schedule registering button 5902, the supply schedule draft 120 may be changed.

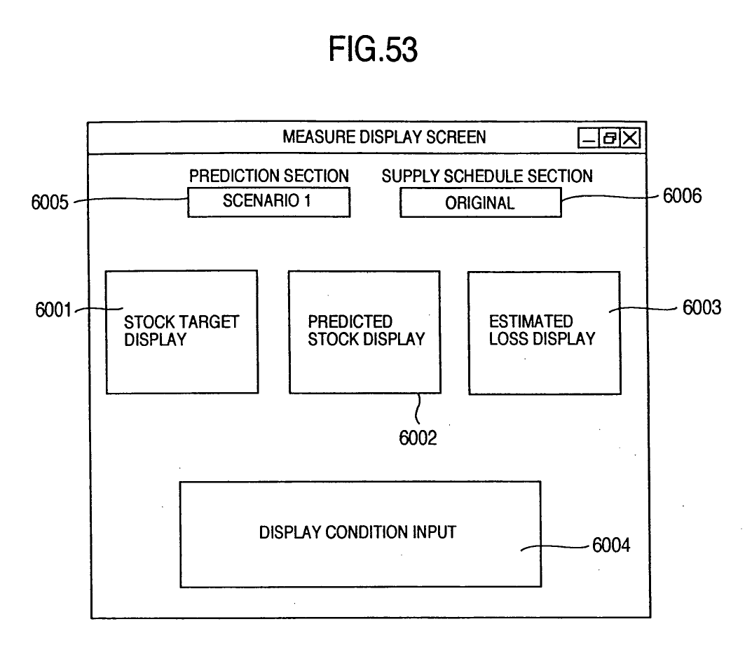

The measure display function 5802 is inputted with the stock target illustrated in FIG. 21, the predicted stock (a quantity and a sum) illustrated in FIG. 58, and the item category master. The item category master includes section information for summing an item of expenditure that is a section of an item, a product type section, and a “part/product/subassembly”. The measure display function 5802 is a function of summing up and displaying the predicted stock 4802 and is executed by the stock and supply schedule support device 106. The summing process is executed with respect to the stock sum of each unit item according to the section of the item category master. However, the stock of the completed product or subassembly is sectioned from the stock of the work-in-process product with reference to the work-in-process flag for stock prediction. About the display process, FIG. 53 shows the summary of the display in the stock and supply schedule support device 106 and FIGS. 54 to 56 shows a concrete example of the display.

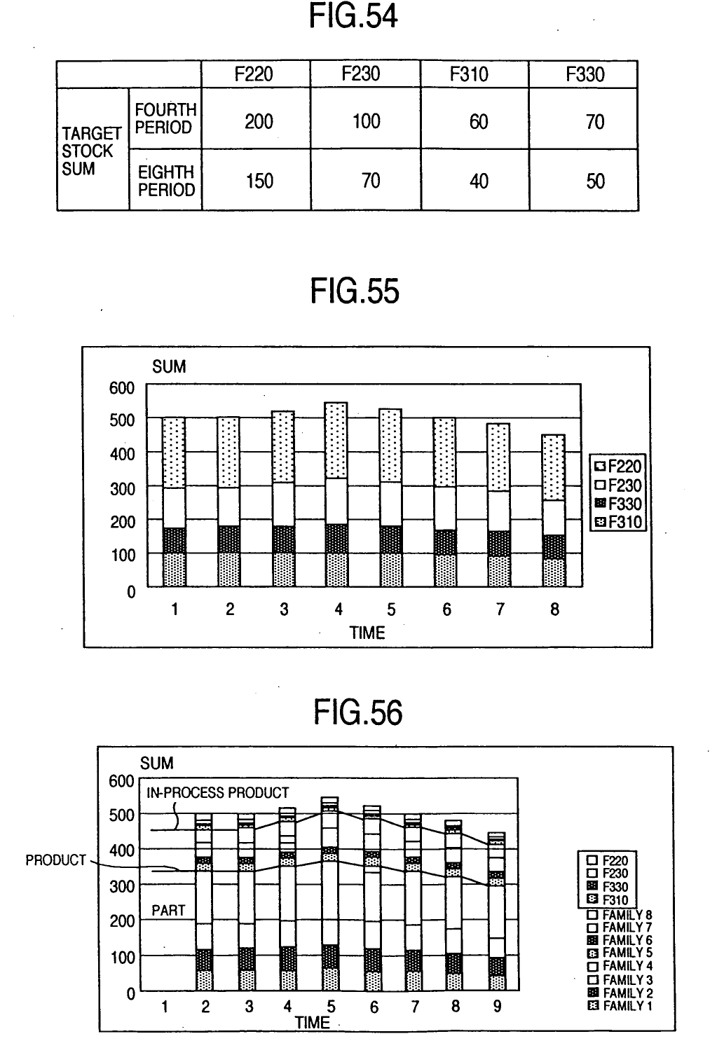

FIG. 53 shows a summary of the screen on which the stock target 112 and each measure of the stock simulated result are displayed. A numeral 6001 denotes a stock target display unit. In FIG. 54, a concrete example will be described. A numeral 6002 denotes a predicted stock display unit, which will be concretely described in FIGS. 55 and 56. A numeral 6004 denotes a display condition input unit that is arranged to be inputted with or select the display conditions for the predicted stock and the estimated loss of inventory price decline. The term “display condition” means the sectioning method of displaying the predicted stock and the estimated loss selectively on a product type basis, on an item of expenditure basis, or on a part item basis. A numeral 6005 denotes the predicted stock (quantity and sum) inputted therein. A numeral 6006 denotes a field in which the supply schedule section (original, change 1, change 2, and so forth) of the inputted supply schedule draft is displayed.

FIG. 54 shows an example of displaying the stock target display unit 6601. The stock target sum inputted into the managerial decision support device 101 by the executive is displayed on a product type basis and a target period basis in a tabular form.

FIGS. 55 and 56 show an example of a display in the predicted stock display unit 6602. FIG. 55 shows an example of a display provided in specifying a product type as the display condition, in which an axis of abscissa denotes a time (on a day basis, a week basis, a month basis, or the like) and an axis of ordinate denotes a sum. In FIG. 55, the stock sum sectioned for each product type is displayed in tabular form. FIG. 56 shows an example of a display provided in specifying a product type and an item of expenditure as the display condition, in which an axis of abscissa denotes a time and an axis of ordinate denotes a sum. In FIG. 56, the stock sum sectioned on the product type basis or the expenditure item basis is displayed in graphical form. Though not shown, if the stock quantity on the expenditure item basis, the part basis, or the specific item basis is specified as the display condition, the stock quantity may be likewise displayed in tabular form.

The foregoing display forms allows the stock target and various kinds of information about the predicted stock to be displayed at a time. Further, the changes of the supply schedule and the prediction section may be executed at a time. Hence, these display forms make it possible to properly and quickly support the decision making of the stock and supply schedule manager.

The foregoing embodiments of the invention makes it possible to quickly convey information between the managerial decision layers and to utilize the predicted result based on the information about the profit and loss and the stock, thereby precisely and properly supporting the decision making of the manager.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A managerial decision support system structure comprising:
a first apparatus that provides an interface for supporting decision making of an executive for drafting a long-range schedule of selling and producing a middle or great deal of a product;
a second apparatus that provides an interface for supporting decision making of a person in charge of profit-and-loss of a sales/production schedule of the product;
a third apparatus that executes a profit-and-loss simulation calculation;
a fourth apparatus that provides an interface for supporting decision making of a person in charge of stock and supply by schedule of the product;
a fifth apparatus that executes a stock simulation calculation;
a sixth apparatus that calculates supply by schedule draft by inputting a middle-range plan draft;
a means, in the first apparatus, for reading from a first database information of actual sales, actual production, and actual stock registered by a generating unit, for indicating marginal balance transition, profitability transition, and/or stock from the past, and for receiving from a user input of a long-range plan draft, profit-and-loss target, and/or stock target;
a long-range plan deployment means, in the third apparatus, for generating a middle-range plan draft out of the long-range plan draft, in accordance with deployment ratio information indicating a ratio between super bill of materials information and sales/production information read from a second database, and for calculating predicted sales by cumulating the long-range plan draft up to a higher hierarchy,
wherein the second database stores the super bill of materials information, which indicates information of a parent-child relationship among structural elements of the product;
a means, in the third apparatus, for calculating the required material amount of the middle-range plan draft, and for comparing the calculated required material amount, supply restraint, and supply capability, to generate schedule feasibility information;
a profit-and-loss calculation means, in the third apparatus, for calculating, by the middle-range plan draft, planned product selling price information and invoice discount ratio information to calculate profit-and-loss in the middle-range production plan level, and in accordance with the super bill of materials information, to calculate predicted profit-and-loss by cumulating the calculated profit-and-loss information up to a higher layer;
a means, in the second apparatus, for disposing information in a constituent tree format from the most significant hierarchy to the least significant hierarchy or the information selected by the user, at least in accordance with information including the long-range plan draft, the middle-range plan draft, planned product selling price, deployment ratio, the schedule feasibility, planned sales, planned profit-and-loss, and the super bill of materials, and for receiving, by the user, the long-range plan draft, deployment ratio, and/or alteration processing of information of the planned product selling price;
a means, in the sixth apparatus, for calculating parts supply draft and daily middle-range plan draft, which is itemized by daily unit, in accordance with the middle-range plan draft and material requirement planning master information;
a stock calculation means, in the fifth apparatus, for calculating delivery information, storage information, and predicted stock, in accordance with the parts supply draft, the daily middle-range plan draft, and the material requirement planning master information read from a third database,
wherein the third database stores material requirement planning master information, including at least goods information, a parts structure list, stock information, predicted storage information, and order restraint information;
a stock money amount calculation means, in the fifth apparatus, for calculating predicted stock including term end stock money account information, in accordance with the predicted stock and planned acquisition cost of inventory;
a means, in the fourth apparatus, for displaying information on a display to receive alteration processing of the parts supply draft, in accordance with the stock target, the parts supply draft, predicted stock including the term end stock money amount information and item category master read from a fourth database,
wherein the fourth database stores item category master information including at least data items of a product item, and material of cost; and
a means for presenting predicted performance transition display of a plurality of managerial measures to receive affirmation of the user or long-range plan draft, profit-and-loss target, stock target or alteration of sales target, in accordance with each information of the long-range plan draft to which alteration processing is conducted, amended plan, the predicted profit-and-loss, predicted stock including the term end stock money amount information, and the predicted sales information and actual sales, actual product and actual stock read from the first database.

2. The managerial decision support system as claimed in claim 1,
wherein the means, in the first apparatus, for reading information, reads the information of actual sales, actual production, and actual stock from the first database, and
wherein a display of the marginal balance transition is exhibited by past record cumulating in a bar graph in which a lateral axis is assigned by geologic age, and a vertical axis is assigned by sales by each product kinds and proportional cost, and also is expressed by transition gram of which vertical axis is assigned with marginal balance.

3. The managerial decision support system as claimed in claim 1, wherein the means, in the first apparatus, for reading information, reads information of actual sales, actual production, and actual stock from the first database, and
wherein a display of the marginal balance transition is exhibited by applying sales of each geologic age to the lateral axis, and applying marginal balance of each geologic age to the vertical axis, and further displaying transitional gram indicating sequence by arrow for the time sequential information at each product models.

4. The managerial decision support system as claimed in claim 1,
wherein the means in the first apparatus reads information of actual sales, actual production, and actual stock from the first database, and
wherein a display of the stock transition is exhibited by applying sales of each geologic age to the lateral axis, and applying sales of each geologic age to the vertical axis, and further displaying transitional gram indicating sequence by arrow for the time sequential information at each product models.

5. The managerial decision support system as claimed in claim 1,
wherein the means, in the first apparatus, for reading information, in accordance with data of actual sales, actual production, and actual stock read out of the first database, displaying actual transition of past geologic age and before present in this geologic age of a plurality of managerial measures by way of a solid line graph, and in accordance with the long-range plan draft to which alteration processing is carried out, amended plan, the predicted profit-and-loss and/or the predicted sales information, displaying predicted value transition of plurality of managerial measures from now on by dashed line graph on the same display.

6. The managerial decision support system as claimed in claim 1, wherein the fourth apparatus, the fifth apparatus and the sixth apparatus are structured on a same server station.
